(19) United States
(12) Patent Application Publication
(10) Pub. No.: US 2025/0133707 A1
(43) Pub. Date: Apr. 24, 2025

(54) SURFACE MERGED HEAT SINK SYSTEM

(71) Applicant: UT-Battelle, LLC, Oak Ridge, TN (US)

(72) Inventors: Himel Barua, Knoxville, TN (US); Lingxiao Xue, Oak Ridge, TN (US); Burak Ozpineci, Knoxville, TN (US)

(21) Appl. No.: 18/908,918

(22) Filed: Oct. 8, 2024

Related U.S. Application Data
(60) Provisional application No. 63/545,373, filed on Oct. 24, 2023.

(51) Int. Cl. H05K 7/20; G06F 30/39; G06F 119/08

(52) U.S. Cl. CPC H05K 7/20927; G06F 30/39; H05K 7/209; G06F 2119/08

(57) ABSTRACT

A system and method for generating a heat sink in multiple dimensions for circuitry, such as a power module, that facilitates removal of heat from the circuitry. To improve power density of power modules, not only electrical but also thermal optimization may be carried out by merging multiple reference sections or anchor planes, each of which may be determined according to a Fourier transform.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF INVENTION

The present disclosure relates to the field of heat sinks, and more particularly to heat sinks for circuitry, such as integrated circuits.

### BACKGROUND

Transportation electrification drives improvements in system efficiency and power density. Inclusion of wide-bandgap (WBG) based semiconductor devices in power modules has shown to raise the power conversion efficiency, however, these devices still exhibit substantial power losses in a small volume. Conventional efforts have focused on removing the generated heat to be able to capture the benefits of advanced semiconductor materials as well as to improve the reliability of the operation for automotive applications. However, these conventional efforts have fallen short in removal heat.

A variety of conventional heat sink geometries are used in liquid-cooled heat sinks, including cold plate, pin-fin, and straight plate fin geometries. Straight plate fin heat sinks have higher heat extraction rates, and lower volume and pressure drops than pin-fin designs for the same flow rate. Cold plate heat sinks have lower volumes but higher thermal imbalances than plate and pin-fin designs. Such conventional heat sinks are designed for maximum heat transfer, uniform heat transfer throughout the area, and low pressure drop. However, when the conventional design methodology is used, the heat sink occupies approximately 24% of the volume of the inverter.

### SUMMARY

In general, one innovative aspect of the subject matter described herein is a heat sink for extracting heat from an integrated circuit (IC) during operation of the IC. The heat sink may include a solid, thermally conductive material with a first surface configured to be thermally coupled with the IC, and a second surface opposing the first interface. The second surface may be arranged to contact a cooling fluid. The heat sink may include a cover arranged and configured to encapsulate the cooling liquid between the cover and the second surface, and form, in conjunction with the second surface, channels that cause the cooling liquid to flow along an effective flow direction. Cross-sections of the second surface that are orthogonal to the effective flow direction may be shaped in accordance with different linear combinations of sinusoidal spatial harmonics, where each linear combination includes a total number of terms, N, that satisfies the conditions 2≤N≠∞, and where the cross-sections are arranged relative to one another to cause the flow of the cooling liquid to meander along the effective flow direction.

The foregoing and other embodiments can each optionally include one or more of the following features, alone or in combination. In particular, one embodiment includes all the following features in combination.

In some embodiments, M≥3 anchor cross-sections from among the cross-sections of the second surface may be spaced apart from each other and distributed along the effective flow direction. Each anchor cross-section may be shaped in accordance with a respective linear combination, and the remaining cross-sections may be shaped to merge the M anchor cross-sections smoothly along the effective flow direction.

In some embodiments, the number of anchor cross-sections further satisfies M≤10. In some embodiments, the total number of terms N satisfies the condition N≤20.

In some embodiments, the terms of the linear combination have corresponding harmonic orders, and a maximum of the harmonic orders is 1000.

In some embodiments, the solid, thermally conductive material includes one or more of Al and Cu.

In some embodiments, a power module may include a substrate and circuitry disposed on the substrate. The heat sink may be disposed on the substrate and may be thermally coupled with the circuitry.

In some embodiments, the power module may include a manifold fluidly connected to the channels of the heat sink and a source of the cooling fluid. The manifold may be configured to supply the cooling fluid, at a first temperature, from the source of the cooling fluid to the heat sink, and return the cooling fluid, at a second temperature larger than the first temperature, from the heat sink back to the source of the cooling fluid.

In some embodiments, the cooling fluid may include one or more of water and glycol.

In some embodiments, the power module may be configured as a power-converter device, and where the circuitry may include Si or SiC-based power-electronic switches.

In general, one innovative aspect of the subject matter described herein can be embodied in a system for designing a heat sink that is liquid-cooled for cooling a power module. The system may include a data processing apparatus and memory encoding instructions that, when executed by the data processing apparatus, cause the system to perform operations. The operations may include (i) accessing parameters comprising (a) a size of the heat sink orthogonal to a flow direction, (b) one or more optimization objectives, and (c) one or more constraints that a combination of the power module and the heat sink must satisfy; (ii) accessing a design space for M≥3 anchor cross-sections of the heatsink surface shaped in accordance with respective linear combinations of sinusoidal spatial harmonics. Each linear combination may include a total number of terms, N, that satisfies the conditions 2≤N≠∞, where the design space includes coefficients, spatial harmonics, and phases of the terms, where the M anchor cross-sections may be spaced apart from each other and distributed along an effective flow direction, and where interpolation cross-sections may be shaped to merge the M anchor cross-sections smoothly along the effective flow direction; (iii) initializing a population of sets of heat-sink cross sections based on the accessed design space, each set including M anchor cross-sections and interpolated cross-sections; (iv) iterating several operations, which may include (a) performing computational analyses of respective power-module and heat-sink combinations based on an instant population of sets off heat sink cross-sections; (b) evaluating fitness of respective power-module and heat sink combinations based on the analyzed instant population in view of the optimization objectives and the constraints; and (c) generating a new population by applying one or more genetic algorithm operators to the instant population evaluated for fitness. The system may perform (v) outputting an optimized population of sets of heat sink cross sections including a set of optimal heat-sink cross sections; and (vi) selecting, based on a particular one of the optimization objectives, a set of heat-sink cross sections from among the group of optimal sets heat-sink cross sections to be used to fabricate the liquid-cooled heat sink.

The foregoing and other embodiments can each optionally include one or more of the following features, alone or in combination. In particular, one embodiment includes all the following features in combination.

In some embodiments, the optimization objectives may include one or more of a heat-sink cross section height, a heat-sink volume, or a coolant pressure drop across the heat sink.

In some embodiments, the constraints may include one or more of a semiconductor-junction temperature, a heat-sink cross-section height, a heat-sink width, a heat-sink length, a heat-sink volume, a Reynolds number, or a coolant pressure drop across the heat sink.

In some embodiments, the computational analyses may include FEA.

In some embodiments, the genetic algorithm operators may include one or more of mutation, cross-over, selection, elitism, or diversity control.

In general, one innovative aspect of the subject matter described herein can be embodied in a heat sink for extracting heat from circuitry during operation of the circuitry. The heat sink may include a first surface configured to be thermally coupled with the circuitry, where a thermal profile is defined at least in part by a thermal coupling between the first surface and the circuitry. The heat sink may include a second surface opposing the first surface and arranged to contact a cooling medium that flows in a flow direction along the second surface. Cross-sections of the second surface that are orthogonal to the flow direction may be respectively defined according to plurality of functions, where each of the plurality of functions is defined by one or more parameters, and where the one or more parameters of each function may be determined based on the thermal profile that is defined at least in part by the thermal coupling between the first surface and the circuitry.

The foregoing and other embodiments can each optionally include one or more of the following features, alone or in combination. In particular, one embodiment includes all the following features in combination.

In some embodiments, the heat sink may include a cover arranged and configured to encapsulate the cooling medium between the cover and the second surface. The cover maybe configured to form, in conjunction with the second surface, channels that cause the cooling medium to flow along the flow direction.

In some embodiments, each function may be a linear combination of sinusoidal spatial harmonics, where the linear combination may include a total number of terms N that satisfies the conditions 2≤N≠∞.

In some embodiments, the cross sections may be arranged relative to one another to cause the flow of the cooling medium to meander along the flow direction.

In some embodiments, M≥3 anchor cross-sections from among the cross-sections of the second surface may be spaced apart from each other and distributed along the flow direction, where each anchor cross-section may be shaped in accordance with a respective function, and where the remaining cross-sections may be shaped to merge the M anchor cross-sections smoothly along the flow direction.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a heat sink generated in accordance with one embodiment of the present disclosure.

FIG. 2 shows pressure drop of a cooling medium in conjunction with the heat sink of FIG. 1.

FIG. 3 shows a Pareto-optimal front of candidate heat sinks generated in accordance with one embodiment of the present disclosure.

FIGS. 4A-E show the candidate heat sinks identified in FIG. 3.

FIG. 5A shows a pin-fin heat sink.

FIG. 5B shows a pressure drop of a cooling medium in conjunction with a heat sink of FIG. 5A.

FIG. 6 shows circuitry in accordance with one embodiment of the present disclosure.

FIG. 7 depicts a thermal profile of a heat sink generated in accordance with one embodiment.

FIG. 8 shows a pressure drop of a cooling medium in conjunction with the heat sink of FIG. 7.

FIG. 9 shows a design space of a plurality of candidate heat sinks generated in accordance with one embodiment of the present disclosure.

FIG. 10 shows a method of generating a heat sink in accordance with one embodiment.

FIG. 11 shows a method of generating a heat sink in accordance with one embodiment.

FIG. 12 shows a method of generating candidate heat sinks for evaluation in accordance with one embodiment.

FIG. 13 shows a Pareto-optimal front analysis relative to two objectives in accordance with one embodiment.

FIG. 14 shows a candidate heat sink in accordance with one embodiment.

FIG. 15 shows a Pareto-optimal front analysis of candidate heat sinks in accordance with one embodiment.

FIG. 16A shows a candidate heat sink identified in FIG. 15 in accordance with one embodiment.

FIG. 16B shows a candidate heat sink identified in FIG. 15 in accordance with one embodiment.

FIG. 16C shows a candidate heat sink identified in FIG. 15 in accordance with one embodiment.

FIG. 17 shows a heat sink generated in accordance with one embodiment of the present disclosure based on a Fourier series.

FIG. 18 shows a comparison of an embodiment relative to a conventional pin-fin heat sink.

FIG. 19 shows a comparison of fluid flow for the heat sink depicted in FIG. 18.

FIG. 20 shows a temperature distribution with respect to operation of a heat sink, generated in accordance with one embodiment of the present disclosure.

FIG. 21 shows a temperature distribution with respect to a conventional heat sink for comparison with the temperature distribution identified in FIG. 20.

FIG. 22 shows a heat sink generator in accordance with one embodiment of the present disclosure.

FIG. 23A shows a method of generating a heat sink according to one embodiment.

FIG. 23B shows a method of generating a heat sink according to one embodiment.

FIG. 24 shows a preliminary view of a heat sink generated in accordance with one embodiment of the present disclosure.

FIG. 25 shows the heat sink of FIG. 24 generated according to one embodiment of the present disclosure.

FIG. 26A shows a temperature gradient of a heat sink according to one embodiment.

FIG. 26B shows a pressure gradient of a heat sink according to one embodiment.

FIG. 27A shows a temperature gradient of a heat sink according to one embodiment.

FIG. 27B shows a pressure gradient of a heat sink according to one embodiment.

FIG. 28 shows a pareto front for generating a heat sink according to one embodiment.

FIG. 29A shows a temperature gradient of a heat sink according to one embodiment.

FIG. 29B shows a pressure gradient of a heat sink according to one embodiment.

FIG. 30A shows a temperature gradient of a heat sink according to one embodiment.

FIG. 30B shows a pressure gradient of a heat sink according to one embodiment.

FIG. 31A shows a sectional view of the heat sink in FIG. 25.

FIG. 31B shows an enlarged, partial view of the heat sink in FIG. 31A.

FIG. 32 shows a sectional view of the heat sink of FIG. 25 according to one embodiment.

FIG. 33 shows an alternative, representative view of the heat sink in FIG. 31A.

### DESCRIPTION

The present disclosure is directed to a heat sink system for circuitry that facilitates removal of heat from the circuitry, such as a power module. To improve power density of power modules, not only electrical but also thermal optimization may be carried out as the two subsystems closely interact with each other. Wide bandgap (WBG) devices incorporated into power modules have become more prevalent in high power density applications primarily because these WBG devices are considered efficient in power conversion and generate heat and small volume. To further increase the power density, a system may decrease power module size or increase power conversion, or both.

In one embodiment, a multi-objective thermal analysis may be conducted by a heat sink generator for generating a heat sink in conjunction with a high power density circuit. The analysis may involve one or more generation algorithms, such as a derivative/gradient/hessian computational algorithm or an evolutionary algorithm. The one or more generation algorithms may be configured for optimization with respect to the heat sink construction. One type of evolutionary algorithm is a population-based evolutionary optimization algorithm. The population-based evolutionary optimization algorithm may not involve derivative computation, which may yield instability. Additionally, the population-based evolutionary optimization algorithm may enable inclusion of constraints that are linear, piecewise, or nonlinear. A heat sink generation algorithm in accordance with one embodiment, such as the population-based evolutionary optimization algorithm, may also be less susceptible to being trapped at a local minima, less susceptible to being trapped at a local extrema, or may avoid gradient computation, or any combination thereof.

In one embodiment according to the present disclosure, a cooling medium in the form of liquid may be employed. This type of cooling medium is often used in automotive applications, where high power density modules and thermal management are considered. A liquid cooling configuration may enable rapid extraction of heat generated by WBG devices and facilitate maintaining device operational integrity.

In one embodiment, a method for design of a liquid-cooled heat sink is provided for power electronic modules. A geometrical representation of the heat sink construction may be based on a Fourier-analysis. This geometrical representation may be used to generate a heat sink construction for the power electronics module, or any other type of circuitry. The geometrical representation based on a Fourier-analysis may describe the geometry of a complex heat sink using a reduced number of parameters or Fourier terms. The power module structure may also be described in a representative manner in conjunction with the geometrical representation of the heat sink, and an evolutionary algorithm may be employed to optimize the heat sink.

In one embodiment, the method may include determining a number of Fourier terms and their associated design space. The method may also include providing these Fourier terms into a geometry-creation system to generate the heat-sink geometry. This geometry may be supplied to a Finite Element Analysis (FEA) system to evaluate its cooling performance. The output of the cooling performance analysis may then be used by an evolutionary algorithm to optimize the heat sink. A genetic algorithm may be selected as the evolutionary algorithm to carry out a constrained multi-objective enhancement, potentially an optimization, of the heat sink.

A system in accordance with one embodiment may be configured to create heat sink geometries using a Fourier-based design system, and optimize the heat sink geometries with respect to considered objectives by employing machine learning (e.g., artificial intelligence) for geometry enhancement or optimization. The system can be utilized to create enhanced or optimal heat sinks that are suitable for conventional manufacturing methods, such as extrusion, casting, and CNC surface machining, as well as additive manufacturing methods.

A system and method in accordance with one embodiment may facilitate creating high power density wide-bandgap based power electronics.

The system and method may be provided for generating a heat sink in a variety of applications, including for instance, in automotive and other applications in the field of transportation. As another example, the system and method may be provided for generating a heat sink in commercial power electronic modules and other applications in the field of energy and utilities.

### I. System Overview

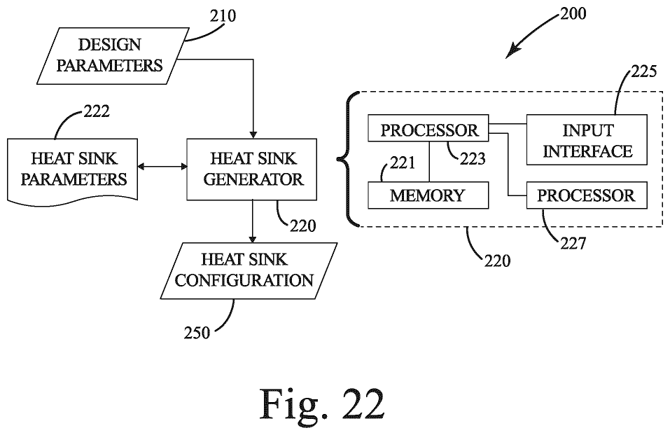

A system in accordance with one embodiment is shown in FIG. 22 and generally designated 200. The system may include a heat sink generator 220 operable to receive design parameters 210 for a heat sink and to generate and store heat sink parameters 222, which can be adapted in accordance with one more embodiments described herein. The heat sink generator 220 may be operable to generate a heat sink configuration 250 for circuitry, such as an integrated circuit. The integrated circuitry may be a power module as described herein, including Si or SiC-based-power-electronic switches. The circuitry may include any type of semiconductor-based power devices, or any combination of different types of semiconductor-based power devices. Example types of semiconductor-based power devices include Si and SiC (as identified previously) as well as GaN, GaO2, and Diamond.

The heat sink generator 200 in the illustrated embodiment may include one or more of the following: a processor 223, memory 221, an input interface 225, and an output interface 227. The input interface 225 may include one or more input communication interfaces, including, for example, wired communication and wireless communication capabilities. Likewise, the output interface 227 may include one or more output communication interfaces, including at least one wired interface and at least one wireless interface, or any combination thereof. The processor 223 and memory 221 may be configured to generate a heat sink configuration according to one or more processes described herein. The memory 221 may store encoded instructions for directing the processor 223 in accordance with one or more embodiments described herein.

The heat sink generator 220 may be coupled to one or more components of the system 200 to achieve operation in accordance with the described functionality and methodology.

The heat sink generator 220 may include any and all electrical circuitry and components to carry out the functions and algorithms described herein. Generally speaking, the heat sink generator 220 may include one or more microcontrollers, microprocessors, and/or other programmable electronics that are programmed to carry out the functions described herein. The heat sink generator 220 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in system 200, or they may reside in a common location within the system 200. When physically distributed, the components may communicate using any suitable serial or parallel communication protocol, such as, but not limited to, CAN, LIN, Fire Wire, I2C, RS-232, RS-485, and Universal Serial Bus (USB).

### II. Heat Sink

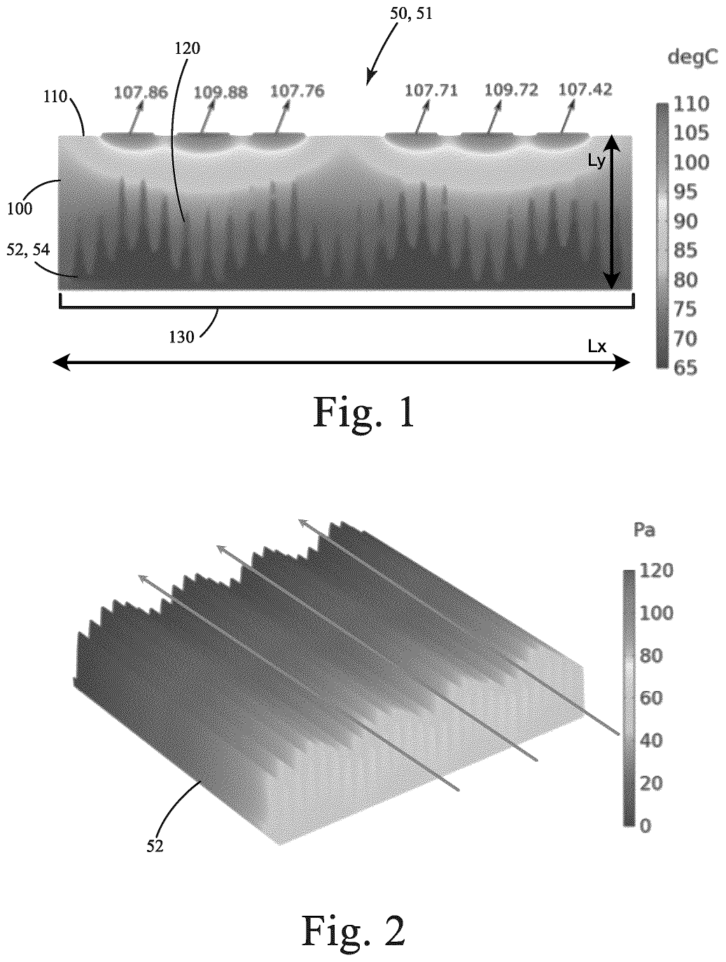

A heat sink in accordance with one embodiment is shown in FIGS. 1-2 and 6, and generally designated 100. The heat sink 100 includes a first surface 110 configured to be thermally coupled to an integrated circuit 50. The integrated circuit 50 may be any type of circuitry and is not limited to integrated circuitry. The heat sink 100 may include a second surface 120 opposing the first surface 110 and arranged to contact a cooling medium 52, such as a cooling fluid in the form of water and/or glycol. A cover 130 may be provided as an optional component where the heat sink 100 is configured to provide a closed channel for the cooling medium 52, such as in the case where the cooling medium 52 is a cooling fluid that flows through a channel 54 defined between the cover 130 and the second surface 120 of the heat sink 100.

The cooling medium 52 may vary depending on the application and is not limited to a fluid. The cooling medium 52 may be any type of medium or a combination of mediums, including any type or combination of liquids and any type or combination of gases, or a combination thereof. For instance, the cooling medium 52 may be primarily in the form of a gas (e.g., atmospheric gas or air) flowing over the second surface 120.

In one embodiment, the cover 130 may be present, and a cooling system having a manifold that directs the cooling medium 52 to and from the channel 54 defined between the cover 130 and the second surface 120 of the heat sink 100. The cooling medium 52 may be supplied from an outlet of the manifold to the channel 54 at a first temperature and returned to an inlet of the manifold from the channel 54 at a second temperature greater than the first temperature.

The integrated circuit 50 may include one or more heat sources, which are thermally coupled to and transfer heat to the first surface 110 of the heat sink 100. A heat transfer profile may be determined along a reference section 51 of the integrated circuit 50 and the heat sink 100. This heat transfer profile may form at least a part of the basis for generating a surface structure of the second surface 120 of the heat sink 100 to facilitate dissipation of heat generated by the integrated circuit 50.

As depicted in FIG. 6, the integrated circuit 50 may include more than one heat source (e.g., components), some of which may intersect the reference section 51 and others of which may not intersect the reference section 51. In the illustrated embodiment, heat sources of the integrated circuit 50 that do not intersect the reference section 51 may be left out of the analysis used by the heat sink generator 200 to generate the heat sink 100. This approach may be considered sufficient for purposes of generating the heat sink 100 because such heat sources not intersecting the reference section 51 may be considered to have negligible or little heat relative to the heat sources that intersect the reference section 51. In an alternative embodiment, the heat sink generator 200 may obtain a heat transfer gradient for all or a portion of an area of thermal coupling between the integrated circuit 50 and the first surface 110, e.g., so that there may be multiple reference sections to generate a plurality of cross sections for the heat sink as described herein. For instance, multiple anchor cross sections may be determined based on multiple reference sections, and these anchor cross sections, which may be orthogonal to the flow direction, may form the basis for a merge that defines a heat sink surface along the flow direction.

The circuitry 50, as described herein, may be formed in a variety of ways, including, for example, as an integrated circuit or as a printed circuit board assembly including one or more integrated circuits disposed thereon. The circuitry 50, in one embodiment may include power electronics having increased power density and reliability in accordance with DOE ELT 2025 targets, such as 100 kW/L, and 300,000 mile lifetime. The substrate and interconnect configurations of the power module may allow for increased power density and enhance reliability for wide bandgap device constructions. Such constructions generate a significant amount of heat, which can be extracted in accordance with one embodiment described herein. The circuitry 50 may include enhanced thermal and power cycling capabilities, as well as low electrical parasitic and integrated gate driver, sensor and protection configurations.

In one embodiment, the heat sink 100 may be generated for a specific construction or design constraints, or both, of the circuitry 50. Generation of the heat sink 100 may be based on heat generation of individual components of the circuitry 50, such as the components modeled with respect to the heat transfer profile for the reference section 51 in the illustrated embodiment. The heat sink 100 may be generated using an evolutionary based algorithm, which may be configured for optimization. This type of heat sink generation may be computationally efficient relative to conventional techniques.

The circuitry 50 in one embodiment may include a module with one device (such as a CPM3-0900-0010A) with 10 mΩ R_{DS} in the top and bottom switching positions. The devices may be attached to a top Cu layer with a 0.05 mm thick 63-Sn/37-Pb solder. A direct bonded Cu (DBC) substrate may be provided with a 0.3 mm thick top Cu layer, 0.3 mm thick bottom Cu layer, and 0.45 mm thick AlN layer. The DBC may be directly soldered with a 1 mm thick heat sink baseplate. A water-glycol mixture (50:50) may be used as a cooling medium. To contain the cooling medium, two 1 mm thick side plates and one 1 mm thick bottom plate may be provided. The coolant flow rate may be 1 L/min, and the inlet coolant temperature may be 65° C. For the heat sink material, Al, may be provided for the heat sink 400 according to one embodiment described herein.

A model of the two SiC devices soldered to the top Cu surface of the DBC may be generated for purposes of evaluation. The model may be varied in cases where the circuitry 50 is configured differently. Each device may have a power loss of 100 W, which corresponds to a heat flux of 316 W/cm². The below table lists the component design parameters of the circuitry 50 in one embodiment:

DESIGN PARAMETERS OF THE POWER MODULE

| Component | Thickness (mm) | Area (mm²) |
|---|---|---|
| SiC | 0.18 | 31.65 |
| Top Cu layer | 0.30 | 1,227.48 |
| Middle AlN layer | 0.45 | 3,963.90 |
| Bottom Cu layer | 0.30 | 1,754.20 |
| Solder (Cu—Sn) | 0.05 | 31.65 |

A heat conduction equation may be coupled with the conservation of mass, momentum, and energy to resolve the fluid flow and heat transfer. The flow rates may be maintained such that the corresponding Reynolds number in the below equation is less than 2,300 to keep the flow pattern laminar. The Mach number of the flow is less than 0.3, and the flow is considered as incompressible.

$$Re = \frac{ρ vd}{μ} ,$$

where Re is the Reynolds number, ρ is the density of the jet liquid, v is the velocity of the jet, d is the diameter of the nozzle, and μ is the viscosity of the liquid. COMSOL may be used for geometry preparation, mesh generation, model development, and solution development. The below table lists the material properties for each layer of the module according to one embodiment:

MATERIAL PROPERTIES FOR EACH
LAYER IN THE POWER MODULE

| | Thermal conductivity | Density |
|---|---|---|
| Component | (W/[m · K]) | (kg/m³) |
| SiC | 450 | 3,200 |
| Top and bottom Cu layers | 400 | 8,940 |
| Middle AlN layer | 180 | 3,260 |
| Solder (Cu—Sn) | 50 | 9,000 |

The local heat transfer coefficient (HTC) may be calculated by the following equation at the interface of the solid and the fluid:

$$h ( x , y ) = \frac{Q ( x , y )}{T ( x , y ) - {T}_{ambient}} ,$$

where Q(x, y) is the local heat flux exiting from the surface, T(x, y) is the local temperature, and T_{ambient} is the inlet temperature of the coolant, which may be 65° C. Local heat flux Q(x, y) and temperature T(x, y) in the solid-fluid interface may be exported from COMSOL directly. If the heat flux is calculated directly from power loss by using power/area, the resulting HTC map is different and less accurate. To calculate the global/average HTC, the area-averaged surface HTC may be calculated by the following equation:

$$h = {[ \frac{1}{A} \int \int ( \frac{1}{h ( x , y )} dxdy ) ]}^{- 1} ,$$

where A is the surface area of heat sink and h is the area global HTC.

### III. Heat Sink Generation and Evaluation

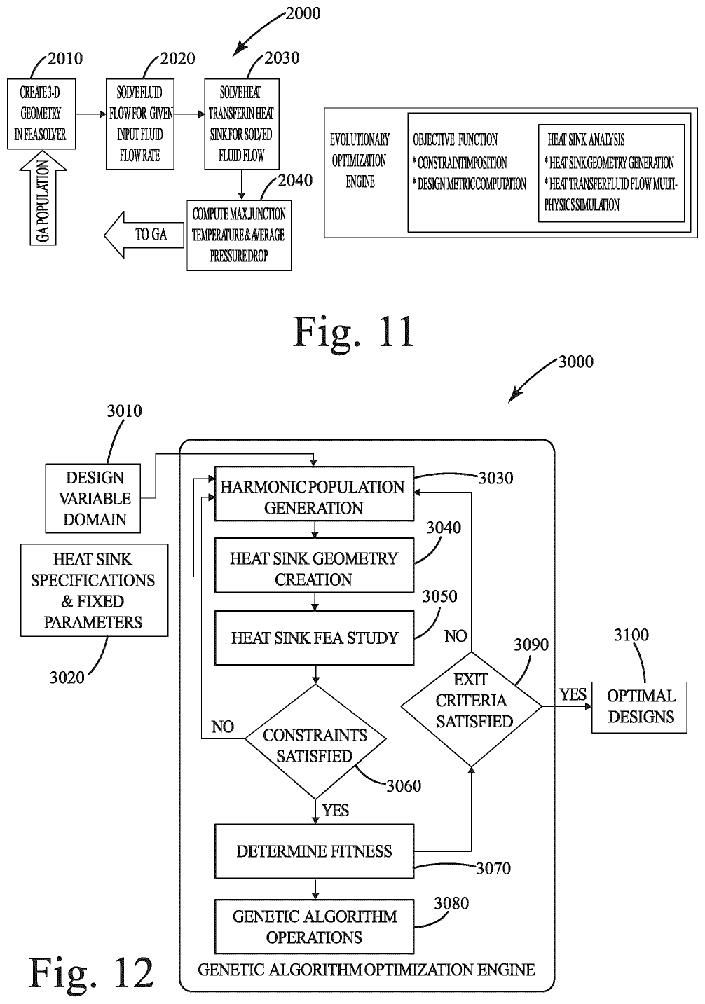

A method of generating and evaluating a heat sink 100 in accordance with one embodiment is shown in FIG. 11 and generally designated 2000. The method may involve evaluating a 3D geometry in a finite element analysis solver. Step 2010. In one embodiment, a significant number of heat sink candidates may be provided for a design space, and a heat sink generation algorithm (e.g., an evolutionary algorithm, such as a genetic algorithm (GA)) may be used to generate, potentially optimize, candidate heat sink solutions that satisfy one or more criteria. The heat sink evaluation algorithm may be based on an objective function (e.g., constraint imposition and design metric computation) in conjunction with heat sink analysis that involves geometry creation and heat transfer fluid flow multi-physics simulations. The heat sink generation algorithm may be implemented as an evolutionary algorithm by the method 3000 depicted in illustrated embodiment of FIG. 12, which may enable multi-objective design optimization or enhancement. The output of the method 3000 may be provided, iteratively, to the method 2000 such that the method 2000 and method 3000 may interact with each other to evaluate heat sinks and generate heat sink configurations and to ultimately yield one or more heat sinks 100 considered best among the candidate heat sink configurations.

The method 2000 for generating the heat sink 100 may include solving fluid flow for a given input fluid flow rate. Step 2020. For instance, in the illustrated embodiment of FIG. 2, fluid pressure is shown for a given flow rate for the heat sink 100 shown in the illustrated embodiment of FIG. 1. In one embodiment, solving fluid flow for a given input fluid flow rate may involve reducing or minimizing a maximum junction temperature of the heat sources and minimizing or reducing cooling pressure drop, while satisfying physical constraints. The method 2000 for generating the heat sink 100 may also include solving heat transfer for a heat sink with respect to the salt fluid flow, and computing a maximum junction temperature and average pressure drop for the heat sink 100 relative to the circuitry 50. Steps 2030, 2040. This information may be provided as design variables and part of the design variable domain 3010 of the method 3000 for further generation of candidate heat sinks for evaluation by the method 2000.

The method 3000 in the illustrated embodiment for generating one or more candidate heat sinks may include a design variable domain 3010 and a fixed variable domain 3020 (e.g., heat sink specifications and fix parameters) provided as input to a harmonic population generator. Step 3030. As described herein, the design variable domain 3010 may receive information from an external evaluator, such as the information received based on evaluation of heat sink candidates in accordance with the method 2000.

The harmonic population generation according to step 3030 may be provided for creation of heat sink geometries (e.g., candidate heat sink configurations). Step 3040. The heat sink geometries may be analyzed in accordance with a heat sink finite element analysis to determine if constraints are satisfied. Steps 3050, 3060. If the constraints and criteria are not satisfied, the process may be repeated until such constraints are satisfied. The constraints and criteria may include maximum junction temperature, pressure drop, Reynolds number and thermal resistance difference between devices on the same substrate. For the finite element analysis, flow of the cooling medium 54 may be assumed to be fully developed laminar, and coolant properties may be assumed to be temperature invariant. It is to be understood that these assumptions may be withdrawn, and aspects of the cooling medium 54 such as the laminar flow and temperature invariant may be modeled or taken into account by the finite element analysis. Constraints considered during the finite element analysis may include a Reynolds number less than 1800 and a semiconductor junction temperature less than a T_{j,max}.

If the method 3000 determines the constraints are satisfied, next fitness and genetic algorithm operations may be conducted. Step 3070, 3080. The method 3000 may determine whether one or more exit criteria have been satisfied based on output of the genetic algorithm operation. Step 3090. If the exit criteria have been satisfied, the one or more heat sink candidate designs or configurations may be output for evaluation in accordance with one or more embodiments described herein.

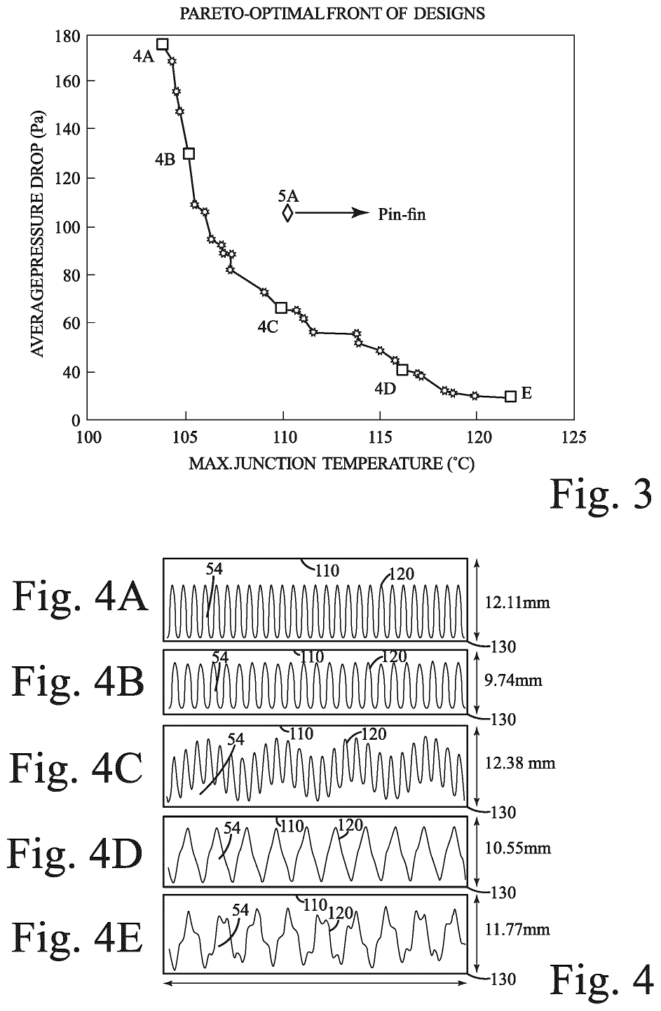

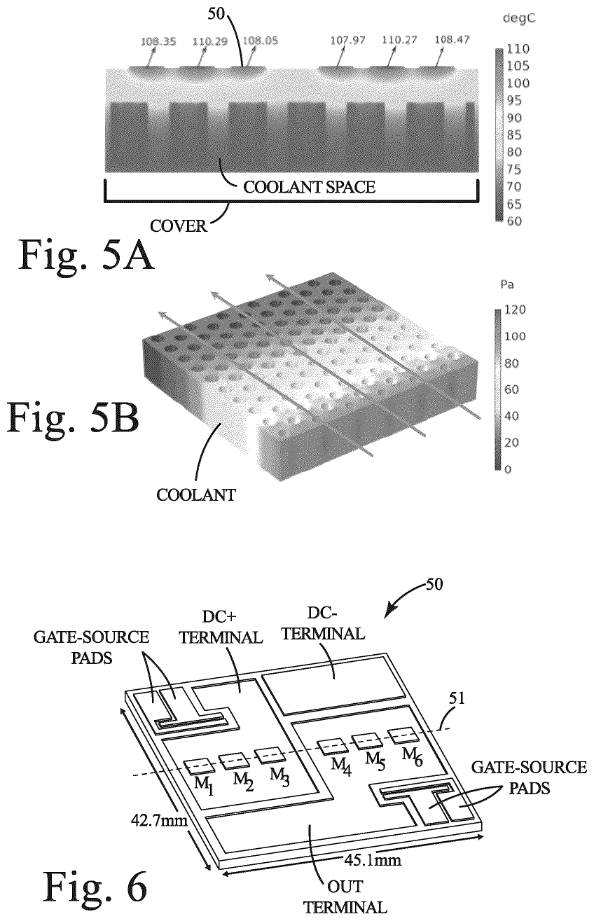

In the illustrated embodiments of FIGS. 3 and 4A-E, of plurality of candidate heat sinks are generated and evaluated in accordance with one or more methods described herein, including the methods 2000 and 3000. The maximum junction temperature in the illustrated embodiments is determined for heat sources of circuitry 50 in the form of SiC MOSFETS. As described herein, the number and type of heat sources may vary from application to application. The average pressure drop across each heat sink candidate is also identified for performance evaluation. For contrast, performance information for a conventional pan-fin heat sink is shown in conjunction with the candidate heat sinks depicted in the illustrated environment of FIGS. 4A-E. For purposes of disclosure, the conventional pin-fin construction is depicted in further detail in FIGS. 5A-B. This conventional pan-fin construction is tailored for uniform cooling with a generally uniform structure, and as can be seen, is less efficient for heat extraction relative to a heat sink 100 generated in accordance with one embodiment. For instance, as can be seen in the illustrated embodiment of FIG. 3, a heat sink 100 generated in accordance with one embodiment of the present disclosure may yield at least a 50% reduction in pressure drop (or heat sink volume) relative to the conventional pan-fin construction of FIG. 5.

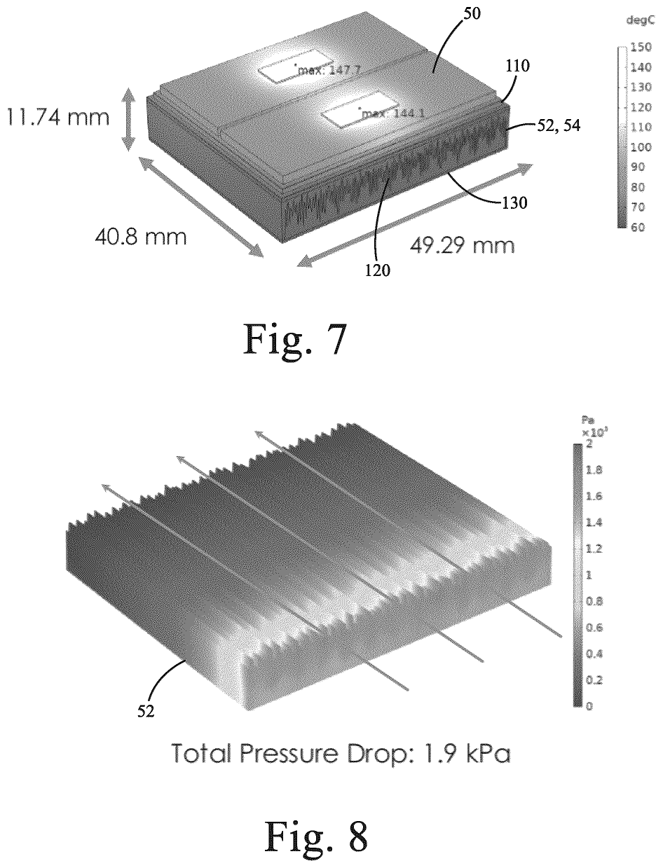

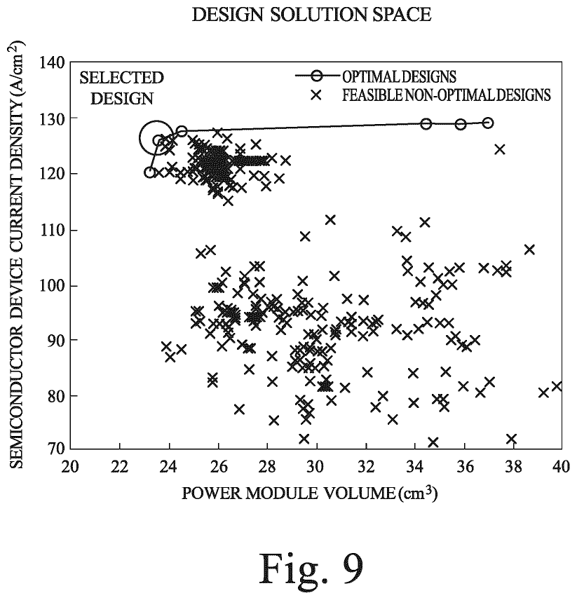

In the illustrated embodiments of FIGS. 7-9, a heat sink 100 in accordance with one embodiment is generated and depicted relative to performance criteria. A heat sink 100 generated in accordance with one embodiment of the present disclosure is shown in FIG. 7, as well as in FIG. 9 among a plurality of other heat sink candidates. The heat sink 100 in the illustrated embodiment may be generated with respect to circuitry in the form of a multilayer organic direct bonded copper (ODBC) substrate. The heat sink 100 in this configuration may be an integrated heat sink generated in accordance with one or more embodiments described herein based on an evolutionary algorithm (e.g., a genetic algorithm) where a GaN HEMT current density and power module volume are provided as optimization parameters.

The heat sink evaluation algorithm (e.g., an evolutionary algorithm), in one embodiment, may be configured to evaluation configurations or constructions for both the heat sink 100 and the circuitry 50. For instance, the evolutionary algorithm may be configured to optimize top copper thickness of the circuitry 50, a module width of the circuitry 50, and the heat sink 100. With this approach, a compact structure, including a compact heat sink structure, may be developed with thermal performance and pressure drop being compliant with respective thermal performance and pressure drop criteria.

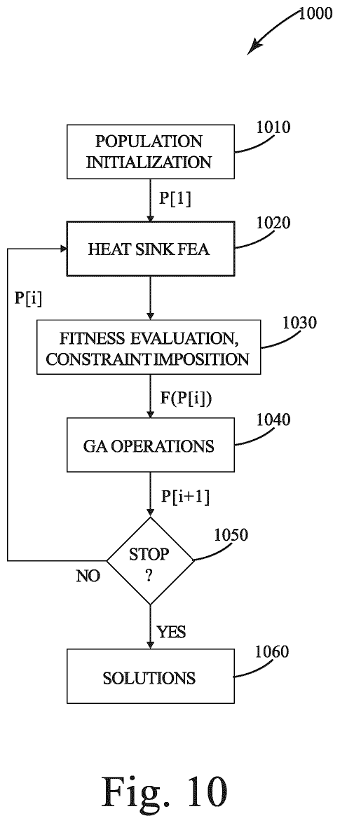

An alternative method of evaluating heat sink candidates and generating a heat sink 100 depicted in the illustrated embodiment of FIG. 10 and generally designated 1000. The method 1000 may be similar to the methods 2000 and 3000 in several respects, including providing input to a heat sink generation algorithm in accordance with one or more embodiments described herein and capable of generating one or more candidate heat sinks. The method 1000 may include generating an initial population of heat sink candidates and evaluation of the heat sink candidates, which may be conducted by a finite element analysis of the heat sink candidates. Steps 1010, 1020. The method 1000 may utilize a current or initial population of heat sink candidates and their associated evaluations to determine a future population of candidate heat sinks. The output of the evaluation may be provided for determining fitness and constriction imposition. Step 1030. The output of the fitness and constriction imposition may be evaluated according to a heat sink evaluation algorithm, such as an evolutionary algorithm (e.g., a genetic algorithm), to operate in conjunction with a heat sink generation algorithm to yield additional heat sink candidates. Step 1040. Example genetic algorithms include one or more operators, such as mutation, crossover, selection, elitism, and diversity control.

These additional heat sink candidates, optionally in conjunction with the previous heat sink candidates, may be evaluated, and fitness and constriction imposition may be determined for the evaluated heat sink candidates. Steps 1040, 1050, 1020, 1030. This process may be conducted iteratively until a heat sink candidate is identified as being compliant with one or more criteria for use as the heat sink 100. Steps 1050, 1060.

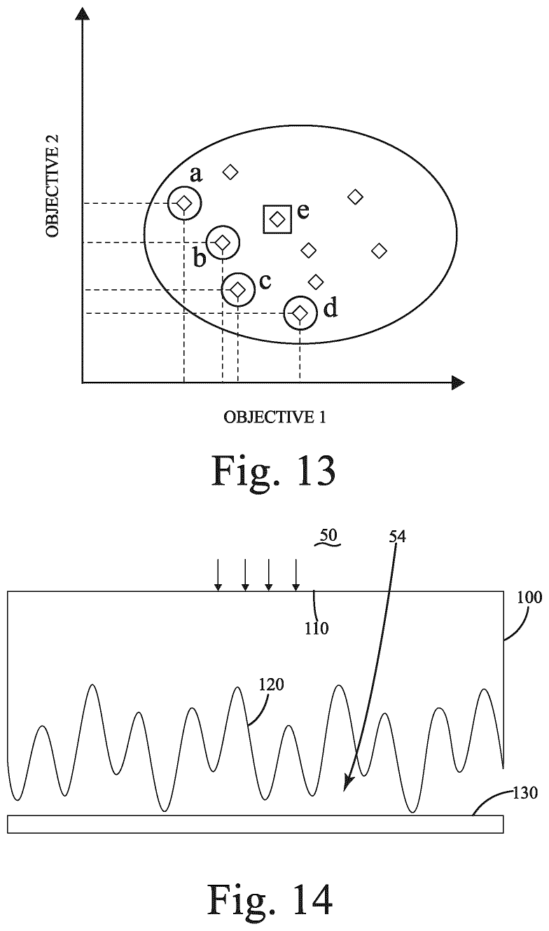

As described herein, sink candidates may be generated and evaluated by a population evaluator, such as a genetic algorithm, and constrained multi-objective optimization. Optimization may yield a solution that satisfies one or more objective criteria or goals. Such an analysis can be conceptualized in accordance with the illustrated embodiment of FIG. 13, with first and second objectives. It is to be understood that additional objectives may be utilized in practice. It is noted that non-contracting objectives may essentially reduce optimization goals. A solution for a set of designs may be Pareto-front. Constrained imposition may enable the system to reject non-viable configurations, and reduce the solution space.

The heat sink 100 may be represented by a parameterized function in accordance with one embodiment. The function may include a plurality of adjustable parameters that may define the second surface 120. The number and values of the parameters may be varied to yield a second surface 120 that facilitate heat transfer from a heat load (in the form of circuitry 50) to a cooling medium 54.

In generating a structural design based on a parameterized function, the number of parameters, which may represent design variables for the structure, may be infinite. A population evaluator, such as an evolutionary algorithm, may rely on the quality of a population for time-efficient analysis (e.g., time-efficient optimization), and a completely random population can lead to a computationally inefficient or sub-optimal solution. A parameterized function in accordance with one embodiment may be capable of defining the second surface 120 in a compact manner with a computationally efficient number of parameters. An example of such a parameterized function that is compact is a Fourier series, which can generate heat sink profiles with relatively few variables (Fourier parameters). The Fourier series includes at least one type of parameterized function operable within sinusoidal orthogonal space, which is considered compact.

The present disclosure is not limited to a Fourier series or a function operable within sinusoidal orthogonal space. Additional or alternative functions and functional spaces that are compact may be utilized. For instance, a functional space operable within an orthogonal space may be utilized, where a geometry may be represented as a linear combination of orthogonal functions.

In the illustrated embodiment of FIG. 14, the parameterized function may be provided in the form of a Fourier series representation of the second surface 120 along the reference section 51 of the heat sink 100. The Fourier series may include a plurality of parameters that can be adjusted to yield a variety of surface configurations for the second surface 120. In the illustrated embodiment, the second surface 120 along the reference section 51 of the heat sink 100 may be substantially uniform along a direction transverse to the reference section 51 and parallel with the flow direction of the cooling medium 52. As a result, the parameterized function may define a 2-D curved line, which in turn defines the second surface 120, that can be varied in accordance with the plurality of parameters. For instance, in the illustrated embodiment of FIG. 14, the second surface 120 is defined by a Fourier series represented as a summation of Fourier series harmonics. As described herein, the second surface may be fixed along the length of the coolant path. The number and/or values of the parameters (e.g., variables corresponding to the number of harmonics of the Fourier series) may be varied to change the structure of the second surface 120. For instance, the second surface 120 may be defined according to the function:

$${F}_{am} ( x ) + {F}_{0} + {\sum }_{n = 1}^{{Nh}_{s}} ( {F}_{h} [ n ] cos ( \frac{2 π}{λ x} h [ n ] x + {ϕ}_{h} [ n ] ) ) ,$$

with parameters defined as,

$${V}_{g} {,}_{j} = {[ {F}_{0} , h [ 1 ] , h [ 2 ] … , h [ {N}_{hs} ] , {F}_{h} [ 1 ] , {F}_{h} [ 2 ] … , {F}_{h} [ {N}_{hs} ] , {ϕ}_{h} [ 1 ] , {ϕ}_{h} [ 2 ] … , {ϕ}_{h} [ {N}_{hs} ] ]}^{T}$$

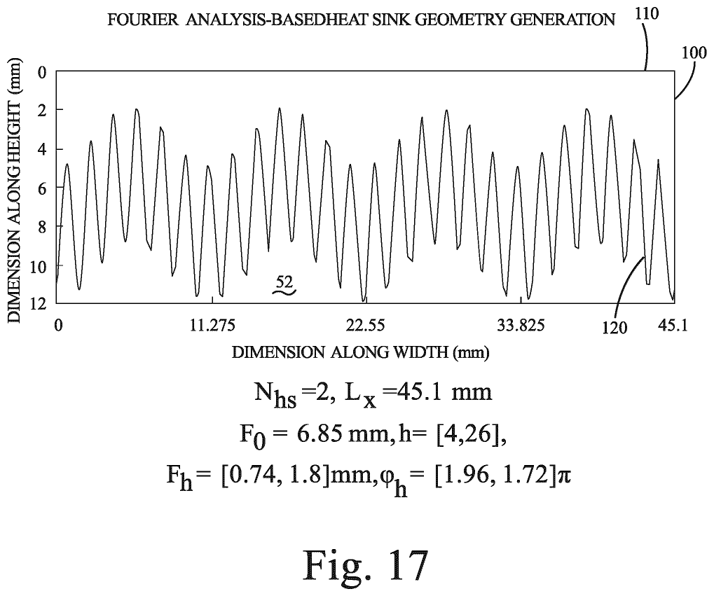

In other words, consider a 2-D surface S confined in area spanned by {0<x<Lₓ, 0<y<L_{y}} in a Cartesian co-ordinate system where Lₓ & L_{y} are maximum allowed horizontal and vertical dimensions, respectively. The 2-D object is additively manufactured starting from y=0. In one embodiment, the structure does not have holes in it, and can be defined using a single dimensional curve with each point of the curve representing the height of the material added to the structure. Using mathematical representation of a stationary wave, the surface of the additively manufactured structure Fₐₘ(x) can be expressed using the summation of sinusoidal harmonics of the equation identified in the preceding paragraph, where F0 is a constant shift, λx is the wavelength (which is also equal to Lx), h[n] is the harmonic order and Fh[n] and φh[n] are its amplitude and phase shift, respectively, and Nhs is the total number of harmonics considered. Total number of variables equals to (3Nhs+1) including the shift F0 in the structure. An illustration of the harmonic geometry generation is shown in FIG. 17, where a complex heat sink structure is represented by two harmonics. The second surface 120 in the illustrated embodiment of FIG. 17 is defined in accordance with the Fourier function with Nₕₛ=2, Lₓ=45.1 mm, F₀=6.85 mm, h=[4,26], Fₕ=[0.74, 1.8] mm, ϕₕ=[1.96, 1.72]π is shown in the illustrated embodiment of FIG. 17. N or the number of harmonics or the number of terms may vary depending on the application, such as from 2 to less than ∞, or from 2 to 20, or from 2 to 1000.

The heat sink configuration (e.g., heat sink DNA) may be defined by Fourier parameters of this function. In this way, a few variables or a reduced number of variables can represent a complex heat sink geometry. In order to arrive at a heat sink construction in accordance with one embodiment, the heat sink generator may adjust one or more of the Fourier parameters, such as the constant shift F₀, the harmonic order, harmonic amplitudes, and harmonic faces, or a combination thereof.

To create a 3-D structure, the 2-D surface may be extended along the third dimension.

In one embodiment, heat sink evaluation according to a method 2000 of the present disclosure may be conducted by the heat sink generator 200 for selecting a heat sink 100 from a plurality of heat sinks generated geometrically. In one embodiment, generation and evaluation may first involve defining a set of variables. For instance, using the Fourier based geometric representation, the harmonic content in a heat sink structure may create a variable space with a size of (3Nhs+1). Few geometrical constraints may be imposed so that the structures comply with constraints. Such geometrical constraints may include limits on minimum and maximum allowed for heat sink height, and a limit on maximum allowed Reynolds number. The heat sink height constraints may limit minimum and maximum possible heat sink volume, and the Reynolds number constraint may limit the flow to be laminar.

Next, the cooling performance of a candidate heat sink may be measured using FEA studies. Heat sink candidates for the circuitry 50 may be evaluated with respect to worst-case steady-state thermal performance. The heat loading conditions used for the heat sink evaluation may be taken for circuitry 50 at its peak power/current load by operating in a steady-state condition.

The circuitry 50 and candidate heat sinks may be analyzed at heat output for peak load, and steady-state FEA simulation may be carried out to simulate the heat transfer and coolant flow in a candidate heat sink. To reduce the computational time for evaluation, the coolant properties may be considered temperature invariant. Furthermore, the coolant flow may be considered to be fully developed laminar with a fixed input volume flow rate at heat sink input surface. The fluid flow and heat transfer under these conditions may be considered weakly coupled. As a result, evaluation in one embodiment may involve a computing coolant flow in the heat sink by assuming a fixed temperature, and then determining heat transfer by using the solved coolant flow.

After the FEA simulation, metrics of interest may be evaluated to determine the design fitness for an optimization engine. Potential metrics of interest are heat sink volume and coolant pressure drop, and minimization may be a target for both heat sink volume and pressure drop. The volume minimization may increase the power density of the circuitry 50, and the pressure drop minimization may reduce the pumping requirements for the fluid.

A Genetic Algorithm (GA) may be used as the optimization engine herein in accordance with one embodiment. Heat sinks 100 may be optimized for junction temperature and average pressure drop across the heat sink. Parameters of the parameterized function, such as the Fourier parameters, may be provided as part of a population set of candidate heat sinks. As described herein, by using a harmonic population of candidate heat sinks, a 2D cross-section of candidate heat sinks can be created. The genetic algorithm passes information to generate a structure of the candidate heat sink, which extends the 2D cross-section in length with a fixed shape for the creation of a 3D candidate heat sink structure. The candidate heat sink may then be combined with the circuitry 50 and pass to a finite element analysis for computation of steady-state heat transfer and coolant flow performance. After the finite element analysis, the heat sink may be verified against imposed constraints. If it is successful in passing the constraints, the genetic algorithm may optimize and use the simulation results to compute a heat sink performance metric using factors such as pressure drop, device temperature, and volume. The performance data may be used to determine design fitness, which the genetic algorithm may then be used to optimize heat sink design population. After optimization, a solution of a multi-objective optimization is a Pareto-optimal front of candidate designs.

The genetic algorithm may rely on a past and current population to determine one or more adjustment variables for a future population based on operators. For instance, the genetic algorithm may run for n operations with each generation operating on m solutions (population size). The Fourier parameters may correspond to design variables, which are stored in a vector to represent a single population element J as:

$${V}_{g} {,}_{j} = {[ {F}_{0} , h [ 1 ] , h [ 2 ] … , h [ {N}_{hs} ] , {F}_{h} [ 1 ] , {F}_{h} [ 2 ] … , {F}_{h} [ {N}_{hs} ] , {ϕ}_{h} [ 1 ] , {ϕ}_{h} [ 2 ] … , {ϕ}_{h} [ {N}_{hs} ] ]}^{T} ,$$

where j∈{1, 2, . . . m}. This design vector v_{g},j can also be viewed as the genetic sequence (i.e., DNA) of the population element.

The GA population at its generation α,P_{g},α, may be stored by using:

$${P}_{g , α} = [ \begin{matrix}{v}_{g , 1} & {v}_{g , 2} & … & {v}_{g , m}\end{matrix} ]$$

where α∈{1, 2, . . . n}, and v_{g,j} is the jth population element. Matrix P_{g,α} may have a size [(3Nₕₛ₊₁),m], where the number of rows (3Nₕₛ₊₁) is equal to the number of design variables for each heat sink, and the number of columns m is equal to the population size or the number of candidate heat sinks in each population.

For a given solution search space, the GA algorithm may start by creating its initial/first population P_{g,1}, which may be generated randomly to capture different regions in the search space. This initial population may then be passed to a computational analysis stage to compute its performance. The computational analysis stage may first use a structure formation tool to generate the heat sink for each member of a population, and may then evaluate performance for each candidate heat sink using FEA. The results of the FEA analysis may be supplied to the genetic algorithm.

The genetic algorithm may use a selection operation to create a mating pool by using population elements with better fitness values. A roulette wheel selection method may be used. The mating pool may be created by using an existing population with selection probability proportional to their fitness value. High fitness population elements may have a higher chance of being selected in the pool. The process may be repeated until the mating pool is full. Using the mating pool, a crossover operation may be performed in which two population elements create two offspring using genetic crossover. The genetic sequence of one parent may be crossed with the genetic sequence of the other parent using a single or multipoint crossover to yield two new population elements. In a single point crossover for gene v_{g,1} and v_{g,2}, a random location identifier between 1 and 3Nₕₛ₊₁ may be selected, and the contents of the two gene sequences may be swapped to create two new offspring. Multipoint crossover may operate in a similar manner by selecting two or more random locations in a gene and crossing over the genetic information.

To mimic genetic evolution, a mutation operation may be performed. With probability pₘ, a gene is mutated so that it's genetic sequence v_{g,j} is modified at a single or multiple positions. At this stage, and elitism operator may also be used to preserve the best genes for a next population to guard these genes from being altered significantly. Additional or alternative genetic algorithm operators may be used, such as a diversity control and random search to control and preserve the population diversity. At the end of the genetic algorithm operations, a new population's algorithm should continue. Verification may be based on the generation counsel that the optimization process may be repeated until n generations. If the generational number is less than n, the heat sink evaluation and same set of genetic algorithm operators may be performed again to create another new population.

In the case of a multi-objective optimization algorithm, where the objective of optimization is to oppose each other, multiple non-dominating solutions may be present and termed Pareto-optimal front of designs. In one embodiment, reducing the heat sink volume decreases the available coolant volume. For a given length of circuitry 50, the coolant volume reduction may also reduce the cooling cross-sectional area, leading to an increased coolant pressure drop across the heat sink. As a result, one target metric (or objective) according to the present disclosure is to minimize heat sink volume and pressure drop, which may counteract each other. The multi-objective optimization approach may determine solutions that are no better than each other. For example, in the illustrated embodiment of FIG. 13, objectives 1 and 2 are minimized, with the 2D plots shown for objectives 1 and 2. The illustrated embodiment demonstrates the available solution region, with diamond points in the region being associated feasible solutions. Because the goal is to minimize both objectives, the solutions in set S={‘a’, ‘b’, ‘c’, ‘d’} are identified by circles because these solutions are considered to outperform other designs.

However, of the four designs in the set S, none is considered better than the other. Design a outperforms all other designs in terms of objective 1, but it does not do well in terms of objective 2 when compared with designs b, c, and d. Similarly, design b performs better than designs c and d, but it does not perform better than design e in terms of objective 1. However, design b performs better than design a in terms of objective 2. Based on similar reasoning, none of the designs and set S outweighs another in all the objectives.

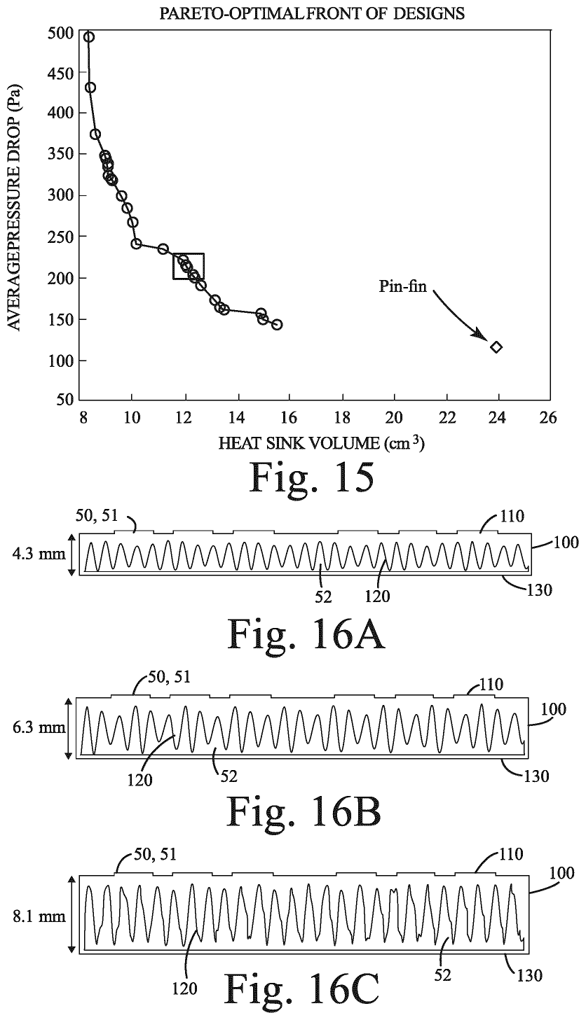

For instance, if the design e is considered relative to set S, with respect to design b, e is the worst in both objectives 1 and 2. As a result, design b dominates design e. Set S is a non-dominated set of solutions in which no design is better than the other, and therefore design e can be included in set S. By using this non-dominated selection scheme, the Pareto-optimal front of designs or candidates for a multi-objective optimization problem can be identified. For instance, with respect to the example discussed herein in connection with FIG. 15, the designs that are boxed-in correspond to a Pareto-optimal front of designs or candidate heat sinks.

As described to herein, candidate heat sinks may be evaluated in accordance with one or more criteria including heat extraction performance. The evaluation may be conducted with respect to the circuitry 50 being modeled under steady-state conditions that generate heat. The evaluation may include constraints such as volume and pressure drop. For instance, a candidate heat sink may be selected as the heat sink 100 for use in practice based on a minimum volume and minimum pressure drop for the cooling medium 52.

In the illustrated embodiments of FIGS. 15-22, a heat sink 100 is generated by the heat sink generator 200 in accordance with one embodiment and compared against a conventional construction. The heat sink generator 200 in the illustrated embodiment may obtain fixed parameters, such as width (45.1 mm) and length (42.7 mm) of the heat sink, each heat source of the circuitry 50 generating steady-state 45 W of loss at 100/3 A, water being used as a cooling medium 52 and supplied at a rate of 10/6 liters per minute and at 65° C., a heat sink material type being aluminum, and the total number of harmonics in the structure being 110. The harmonic order may be limited between one and 100. The design space considered by the heat sink generator 200 may include 1040 candidates, and the genetic algorithm may utilize 40 population elements, operating for 40 generations. In practice, total computation time on an eight core CPU for this configuration may be approximately five days.

Operative values for heat sink volume in average pressure drop relative to a heat sink construction that achieves an acceptable level of heat extraction from the circuit 50 are shown in the illustrated embodiment of FIG. 15, with several example embodiments of such heat sink constructions depicted in the illustrated embodiments of FIGS. 16A-C. A conventional pan-fin heat sink is identified in FIG. 15 for reference.

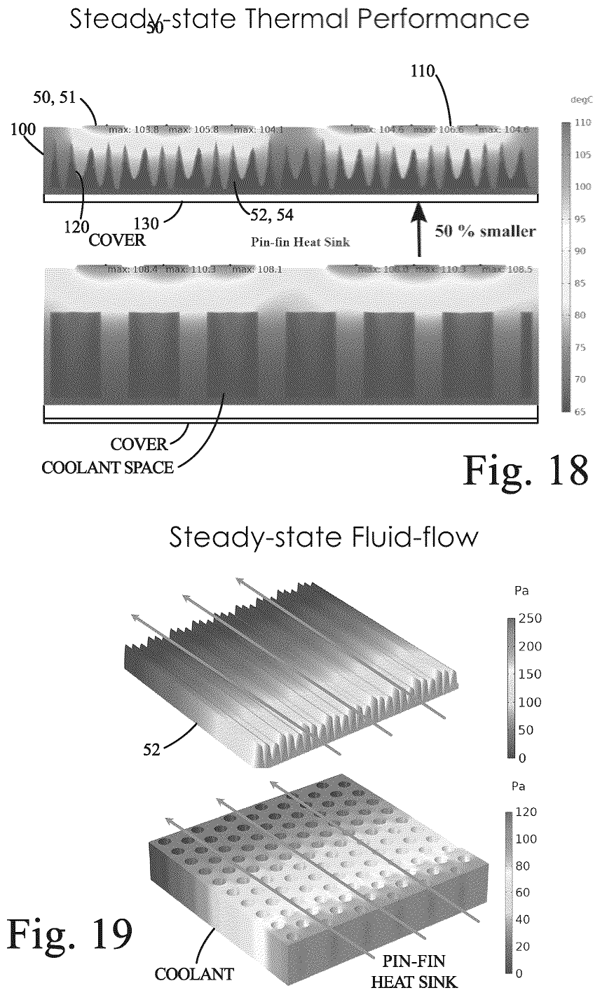

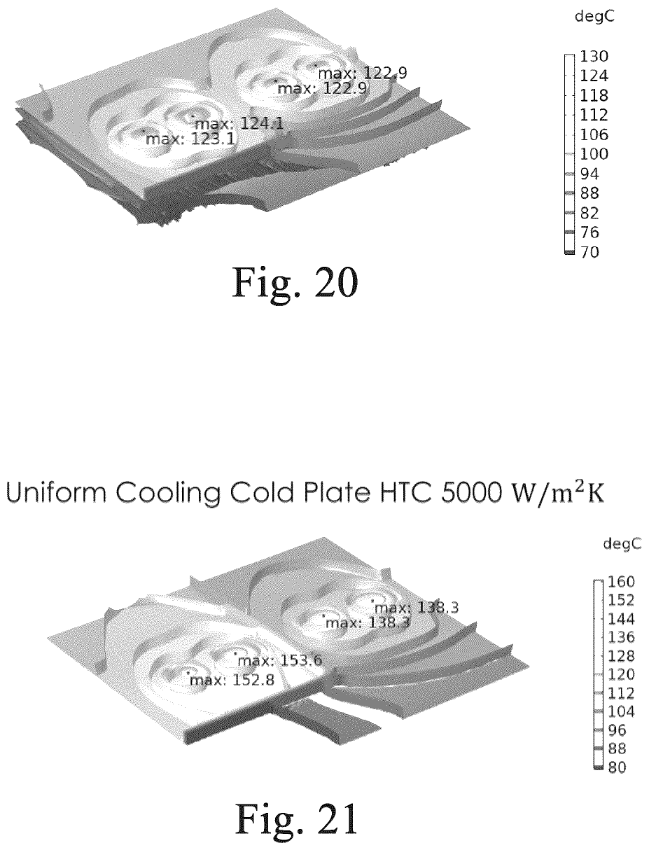

As can be seen, a heat sink 100 generated in accordance with one embodiment of the present disclosure may achieve 33 to 63% volume reduction relative to the conventional pin-fin heat sink construction. Relative to the pin-fin heat sink construction, the heat sink 100 has an additional pressure drop of approximately 110 Pa, adding about 20 W per meter squared or less than 5 mW extra pump power requirement. This additional power requirement for pressure drop is considered acceptable or within design parameters relative to gains achieved in volume reduction. Steady-state thermal performance and fluid flow comparisons for a conventional pin-fin heat sink construction and a heat sink 100 generated in accordance with one embodiment of the present disclosure are depicted in the illustrated embodiments of FIGS. 18 and 19. Likewise, temperature distribution for the heat sink 100 generated in accordance with one embodiment of the present disclosure is depicted for the circuitry 50 in FIG. 20, and temperature distribution for a conventional pin-fin heat sink construction is depicted for the same circuitry 50 in FIG. 21.

The heat sink generator 200, in generating a heat sink 100 based on an evolutionary algorithm and finite element analysis may enable development of heat sink configurations tailored for specific objectives. In one embodiment, an optimal heat sink configuration may be generated to yield significant performance improvements relative to a conventional configuration.

A heat sink 100 generated in accordance with one or more embodiments of the present disclosure may be manufactured in a variety of ways. The material type of the heat sink may vary depending on the application, and as described herein, properties of the material type may affect the analysis and generation of the heat sink 100. Example materials include aluminum and copper. Example manufacturing methods include the heat sink 100 being machined from metal stock (e.g., aluminum stock), die cast, or 3-D printed via multi-layered metal deposition.

In one embodiment, it is noted that the circuitry 50 may be generally optimized for minimum electrical parasitics (e.g., stray inductance) by considering the minimum spacing between dies for thermal decoupling. The layout of the circuitry 50 may assume sufficient heat spreading and transfer from dies to a cooling structure. For circuitry 50 that uses a direct substrate cooling method, the base plate may be removed, leading to a steady-state thermal asymmetry in the circuitry 50 due to insufficient heat spreading/transfer. This may cause significant temperature differences among the devices in the circuitry 50. Such unintentional thermal asymmetries can lead to undesirable asymmetries in operation, such as asymmetry in power conversion among semiconductor devices for circuitry 50 in the form of a power module. This asymmetry can impact reliability.

With advances in power conversion density, the heat sink generator 200 may be configured to also consider uniformity in operation of semiconductor devices of the circuitry. One aspect of uniformity is the observed thermal impedance by semiconductor chips in the circuitry 50. In the absence of sufficient heat spreading or transfer in advanced packaging schemes for circuitry 50, individual semiconductor devices may experience differences in the thermal impedance offered by the cooling system. For steady-state operation, such thermal impedance imbalances may lead to significant temperature differences among components (e.g., devices) of the circuitry 50.

One embodiment of the heat sink generator 200 described herein, operating in accordance with one or more methods of the present disclosure may mitigate thermal imbalance via evolutionary optimization. For instance, a heat sink 100 may be generated for a substrate of the circuitry 50 so that steady state temperature imbalance among components of the circuitry 50 is minimized or reduced. In the case of the circuitry 50 being a power module, the power conversion density may be maximized.

The thermal loading of each component of the circuitry 50, for FEA simulations, may be increased by a factor of αₕₗ>1 where the cooling system may be retained and component temperatures may be computed. The incremental thermal resistance for each component of the circuitry may be computed as:

$${R}_{th , inc , ξ} = \frac{{T}_{j} , max , {a}_{hl} , ξ - {T}_{j} , max , 1 , ξ}{( {a}_{hl} - 1 ) {P}_{cw} , ξ}$$

where ξ∈{M₁,M₂, . . . } are the components of the circuitry 50, Tⱼ,max,αₕₗ,ξ is the maximum component temperature at aₕₗ factor load, and P_{cw}, ξ is the continuous peak-rated loading condition for component ξ. The imbalance in the study-stay thermal resistance R_{th,im} may be defined as:

$${R}_{th , im} = \begin{matrix}max \\ ξ\end{matrix} ( {R}_{th , inc , ξ} ) - \begin{matrix}min \\ ξ\end{matrix} ( {R}_{th , inc , ξ} )$$

In order to reduce the study-stay thermal imbalance, a metric for evaluation in conjunction with the genetic algorithm may include R_{th,im}, with a target for minimization of this metric. In other words, an optimization algorithm in accordance with one embodiment may identify a Fourier series variable set that minimizes the difference in thermal impedance relative to one or more other Fourier series variable sets.

With a mathematical definition of thermal imbalance, the heat sink generator 200 in accordance with one embodiment may generate heat sinks for a given layout of circuitry 50 for a given maximum current rating and maximum heat loading.

The heat sink geometries may be represented as a combination of armada geometries and a DC constant F₀. For a given current load (or heat loaded), module layout, cooling parameters, coolant flow rate, and heat sink material parameters, the heat sink construction may be modeled according to the following:

$${F}_{hs} ( x ) = {H}_{0} + {\sum }_{n = 1}^{{Nh}_{s}} ( {A}_{h} [ n ] cos ( \frac{2 π}{λ x} h [ n ] x + {ϕ}_{h} [ n ] ) ) ,$$

$$x ∈ [ 0 , {W}_{x} ]$$

And, the design variable vector (or geometrical design vector θ_{g} may be given as:

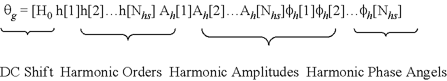

The length of the θ_{g} vector is (3Nₕₛ₊₁), and the limits on each element in θg may be determined from the limits on the maximum allowed height and volume constraints.

Along with the variable vector, a few fix parameters may be stored in vector D as:

D=[M_{fp}C_{fp}S_{cp}]

where M_{fp} may contain all of the fix parameters of the circuitry layout and its current loading; C_{fp} may contain all the fix parameters of the cooling system such as: parameters, flow rate, and material parameters; and S_{cp} may contain all constrained parameters for the design, such as limits on the maximum junction temperature and maximum coolant temperature rise.

One or more additional constraints may be imposed on the heat sink construction to assist the heat sink generator 200 in discarding solutions or spaces that either do not yield physically viable designs or fail to fulfill a design criteria. The first constraints imposed may include a uniqueness of the harmonic selection. That is, the vector h in θ_{g} may be constrained to contain unique elements:

$$h [ {n}_{1} ] \neq h [ {n}_{2} ] ,$$

$$∀ ( {n}_{1} , {n}_{2} ) ∈ \{ 1 , 2 , … {N}_{hs} \} ,$$

$${n}_{1} \neq {n}_{2} .$$

In other words, and inequality constrained may be imposed such that:

unique(h)≥Nₕₛ

where unique (h) computes the number of unique elements in the vector. It is noted that this equation includes unique elements in h that may always be less than or equal to Nₕₛ because the number of elements in h equal Nₕₛ. A greater than equal to inequality may be imposed, keeping population-based algorithms in mind in case of convergence with the quality constraints.

A constraint and the height of the heat sink Hₕₛ may be imposed such that:

Hₕₛ=(max(Fₕₛ)−min(Fₕₛ))≤H_{ht,max},

where H_{ht,max} is the maximum allowed heat sink height. For a given layout of the circuit 50, this constraint may also limit the maximum value of the allowed volume.

Additional or alternative constraints may be imposed on the solution of the heat sink FEA simulation. For instance, constraints such as the fluid flow being fully developed laminar to reduce computational time may be imposed. The Reynolds number of the fluid flow solution R_{N,hs} may be maintained below a maximum threshold:

R_{N,hs}≤Reₘₐₓ

To limit the semiconductor temperature, a constraint may be imposed on the maximum component (e.g., die) temperature:

ξ^{max}(T_{sic,ξ})≤T_{sic,max},

where T_{sic,ξ} is the temperature of die ξ, and T_{sic,max} is the maximum allowed SiC chip temperature for an application.

The change in coolant inlet and outlet surface average temperature may be constrained by:

T̅_̅{̅c̅,̅o̅u̅t̅}̅−T̅_̅{̅c̅,̅m̅}̅≤δ_{T,c,max},

where T̅_̅{̅c̅,̅m̅}̅ and T̅_̅{̅c̅,̅o̅u̅t̅}̅ are the surface average coolant temperatures that the inlet and outlet, respectively and δ_{T,c,max} is the maximum allowed change in coolant temperature.

In one embodiment, the heat sink generator 200 may be configured to maximize power density of the circuitry 50 as well as minimize imbalance and thermal resistance. The maximum allowed current rating of devices of the circuitry may be known before optimization, therefore maximizing power density may be an exercise in minimizing power module volume Vₚₘ. Power module volume with a heat sink may be computed as:

Vₚₘ=Wₚₘ·Lₚₘ·(Hₚₘ+Hₕₛ),

where Hₚₘ is the thickness of the layout of the circuitry 50 including components, such as SiC devices, and substrate, and Wₚₘ and Lₚₘ are the width and length of the circuitry 50, respectively. The thermal resistance metric R_{th,im} may be computed after numerical simulation of the circuitry 50 with a candidate heat sink.

The selection function for the genetic algorithm may be expressed as:

$$f = \{ \begin{matrix}{ε [ \begin{matrix}1 & 1\end{matrix} ]}^{T} ( \frac{{C}_{s} - {N}_{C}}{{N}_{C}} ) {C}_{s} < {C}_{1} \\ {[ \frac{1}{{R}_{th , im}} \frac{1}{{V}_{pm}} ]}^{T} {C}_{s} = {C}_{1}\end{matrix}$$

$$where$$

$${C}_{s} = {\sum }_{i = 1}^{{N}_{c}} {c}_{i} ,$$

and where N_{c}, Cₛ, and C_{I} are the total number of constraints, the number of team constraints are satisfied, and the number of strains imposed during the evaluation of the objective function respectively. cᵢ may be the ith constraint, and ε may be a small positive number on the order of 10⁻⁶.

Computation of cᵢ may be conducted such that if it is less than equal to a constraint of the form x≤xₘₓ,

$${c}_{i} ( x , {x}_{mx} ) = \{ \begin{matrix}1 & x \leq {x}_{mx} \\ \frac{1}{1 + x - {x}_{mx}} & x > {x}_{mx}\end{matrix} ;$$

otherwise, for a greater than equal to constraint of the form x≥xₘₙ,

$${c}_{i} ( x , {x}_{mn} ) = \{ \begin{matrix}1 & x \geq {x}_{mn} \\ \frac{1}{1 + {x}_{mn} - x} & x < {x}_{mn}\end{matrix} ;$$

If constraint i is satisfied, cᵢ=1; otherwise, cᵢ<1. If all the constraints are not satisfied, the objective function may yield a small negative number. Otherwise, the inverse of the design metrics may be calculated. These forms of constraint and fixedness functions may be advantageous for generating a heat sink in accordance with one embodiment of the present disclosure, with a heat distribution that is less imbalanced as depicted in illustrated embodiment of FIG. 20 relative to the less balanced distribution of a conventional heat sink depicted in illustrated embodiment of FIG. 21.

### IV. Merged Heat Sink Generation and Evaluation

In one embodiment according to the present disclosure, the heat sink 100 may be generated according to a mathematical expression or function. For instance, an FFT function may be utilized to represent a two-dimensional profile of the heat sink 100—i.e., to define a cross section of the heat sink 100. In one embodiment, to optimize the heat sink geometry, the first step is to represent the geometry by a mathematical expression where the shape can be represented by as few variables as possible. In the heat sink 100, the heat sink profile may be defined according to the following equation:

$${F}_{am} ( x ) = {F}_{0} + {\sum }_{n = 1}^{{N}_{hs}} ( {F}_{h} [ n ] cos ( \frac{2 π}{{λ}_{x}} h [ n ] x + {ϕ}_{h} [ n ] ) ) ,$$

where x∈[0,Lₓ]; F₀ is a baseplate thickness of the heat sink; λₓ is the wavelength of the heat sink in space, which is the same as the heat sink width Lₓ; h[n] is the harmonic order; Fₕ[n] is the amplitude; and ϕₕ is the shift. By using two harmonics, a complex heat sink structure can be generated. To create the 3D geometry, the heat sink 100 in one embodiment is generated by extruding the surface defined according to the function.

Alternatively, instead of having a single 2D profile, multiple 2D profiles may be created at different locations within the boundary—e.g., for multiple reference sections of the circuitry.

It is to be understood that the generator 200 described herein for producing the heat sink 100 may be modified according to the methods and systems described herein to generate the heat sink 400.

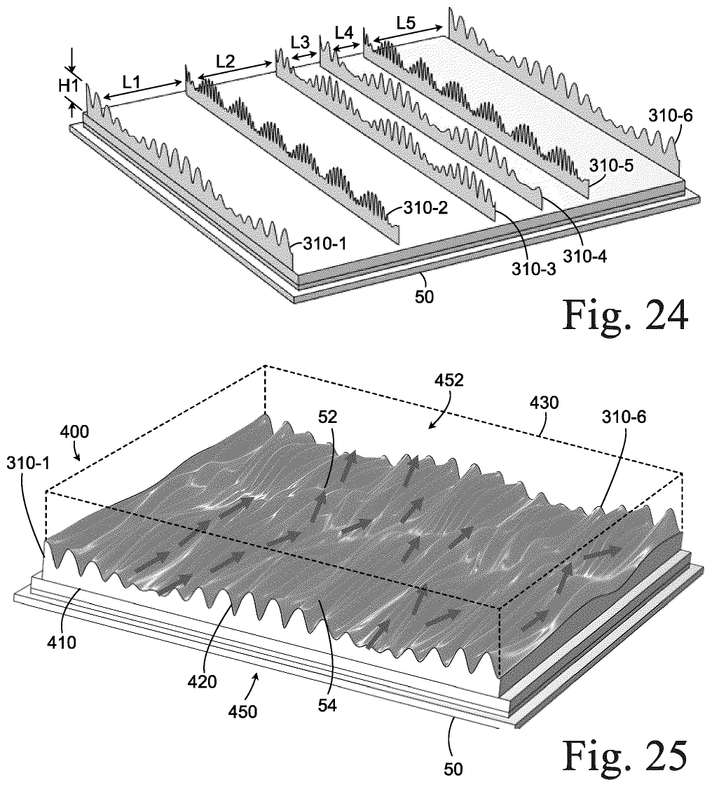

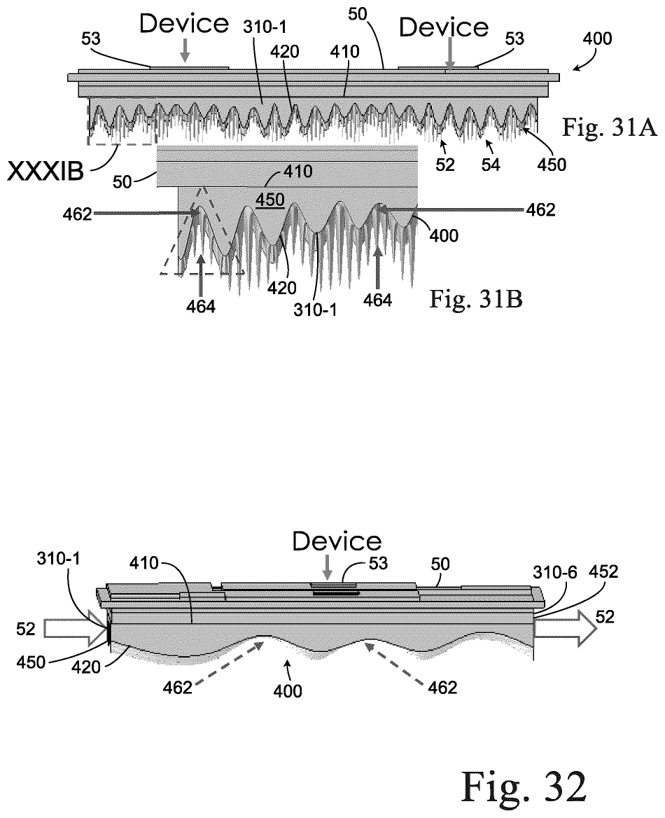

For instance, in FIGS. 24, 31A-B, and 32, the circuit 50 is shown with components 53 relative to a plurality of reference sections 310. Five reference sections 310 are shown in FIG. 24, designated 1, 2, 3, 4, 5, but additional or fewer reference sections 310 may be provided. The reference sections 310 may be considered working planes and may be utilized to facilitate generating a plurality of anchor cross-sections of a heat sink 400 that is similar to the heat sink 100 in many respects but different in others as described herein.

The heat sink 400 according to one embodiment is shown in FIG. 25. The heat sink 400, like the heat sink 100, includes a first surface 410 configured to be thermally coupled to the integrated circuitry 50 and a second surface 120 opposing the first surface 110 and arranged to contact a cooling medium 52. Although not shown in FIG. 24, a cover 430, similar to the cover 130, may be provided in conjunction with the heat sink 400 as an optional component where the heat sink 400 is configured to provide a closed channel for the cooling medium 52, such as in the case where the cooling medium 52 is a cooling fluid that flows through a channel 54 defined between the cover 430 and the second surface 420 of the heat sink 400, and may define a first end 450 (e.g., an inlet) and a second end 452 (e.g., an outlet) for the cooling medium 52 to flow through the channel 54. It is noted that the cover 430 is optional, so that the channel 54 may be an open channel relative to the second surface 420. In this sense, the open channel arrangement may allow for the flow of cooling medium 52 across the second surface 420 from the first end 450 to the second end 452. The heat sink 400 according to one embodiment may include one or more high speed zones 462 and one or more low speed zones 464 with respect to flow rate of the cooling medium 52 through the channel 54 relative to the second surface 420 of the heat sink 400, as depicted in FIGS. 31B and 32. The high speed zone 462 may be close to the second surface 462 which helps to extract heat. The low speed zone 464 may be farther from second surface 462 which helps to reduce the pressure drop. The reference section 51 in the heat sink 100 is generally uniform along the flow direction, whereas the plurality of reference sections 310 of the heat sink 400 provide a second surface 420 that varies along the flow direction. Such variation in the heat sink 400 along the flow direction as well as the variation in the reference section 310 may provide a more complicated or tortuous flow path relative to the heat sink 100, causing turbulence which allows higher heat transfer performance.

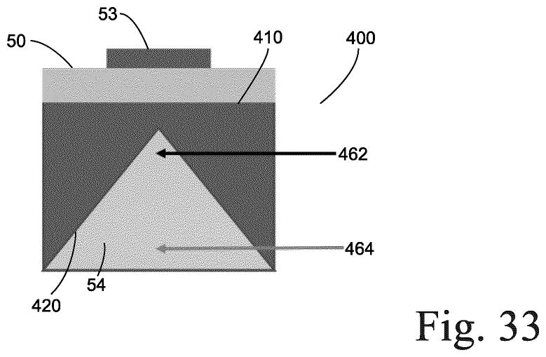

The velocity gradient across the channel 54 may vary according to the geometry of the heat sink 400 and the second surface 420 thereof; and, the velocity gradient may affect heat extraction via the coolant medium 52 flowing in the channel 54. In FIG. 33, the flow rate can be determined as the velocity*area. A high velocity zone may be close to the heat source to extract heat, and a low velocity zone may be far from the heat source and reduce pressure drop.

The reference sections 310 in FIG. 24 may be positioned in a variety of locations, including a first reference section 310-1 at the inlet 450 and a sixth reference section 310-6 at the outlet 452 of the heat sink 400. The second, third, fourth, and fifth reference sections 310-2, 3, 4, 5 may be provided at different distances between the inlet 450 and the outlet 452 and the first and sixth reference sections 310-1, 6. In the illustrated embodiment, the first and sixth reference sections 310-1, 6 are configured the same and referenced herein in determinations and calculations as 310-1—however, it is to be understood that the reference sections 310-1, 310-6 may be configured differently and separately analyzed for purposes of determining and generating the heat sink 400.

In FIG. 24, each reference section 310 may be configured with a height H and a length L, which may correspond to a distance from the reference section 310 to a downstream reference section 310 as the cooling medium 52 flows from the first end 450 to the second end 452. The height H and length L may be provided a parameters that can be varied for one or more of the reference sections 310 (other than the length L for a reference section 310 aligned with the second end 452) for determining a heat sink configuration with enhanced performance characteristics, optionally with an optimization algorithm to determine optimal lengths, optimal heights, and optimal cross sections for each of the reference sections 310.

In one embodiment, a Loft operation may be utilized to merge one reference section 310 to another reference section 310, thereby forming the second surface 420 of the heat sink 400. A loft operation may enable merging of multiple surfaces that are not similar in terms of cross section. It is to be understood that additional and/or alternative merging methodologies may be utilized. For instance, an extrude can be applied if the surfaces are similar, or a sweep operation may be utilized if the surfaces are similar but on different planes and connected through a guide curve. In some cases, these operations may not be interchangeable, e.g., sometimes only one operation can be applicable for a certain geometry. The choice of merging operation or operations may depend on the implementation and the geometry.

In one embodiment, to generate the heat sink 400, variables and constants may be defined (e.g., to provide an optimization algorithm to generate the heat sink 400). In order to enhance (possibly optimize) the heat sink geometry for improved cooling performance, the power module layout of the integrated circuit 50, including the location of the devices and thicknesses of different layers of substrate may be assumed to be fixed. The heat sink material and type of cooling medium 52 may also be fixed. The structural design of the heat sink 400 may be variable and represented by several parameters that can be varied. For instance, parameters or variables that can be varied include the frequency of fins in each reference section 310 (e.g., each plane), height H of the heat sink 400 as a whole, and the length L of the heat sink 400 as a whole. Alternatively, or additionally, the frequency of fins in each reference section 310 (e.g., each plane), height H of each reference section 310, and the length L of each reference section 310.

The construction of the heat sink 400 may be generated considering worst-case steady-state thermal conditions. That is, the heat loading conditions used for generating the heat sink 400 may be taken for an integrated circuit 51 at its peak power/current load while operating in steady-state conditions. The cooling performance of the heat sink 400 may be measured in terms of device temperatures and pressure drop in the system. To reduce the computational time, some assumptions may be made. For instance, fluid dynamics and thermal dynamics may be one-way coupled, which means the analysis may be split into two physics. First, the coolant flow for the heat sink 400 may be solved, and later the heat transfer for heat sink 400 and the integrated circuitry 50 may be solved. For increased accuracy, both physics may be coupled for the analysis.

In one embodiment, coolant properties may not be considered dependent on temperature because the coolant temperature increased by approximately 5° C., which would not have changed the properties much. For purposes of analysis, the flow rate may be kept at 1 L/min, where the Reynolds number was within 2,300 and flow conditions were laminar.

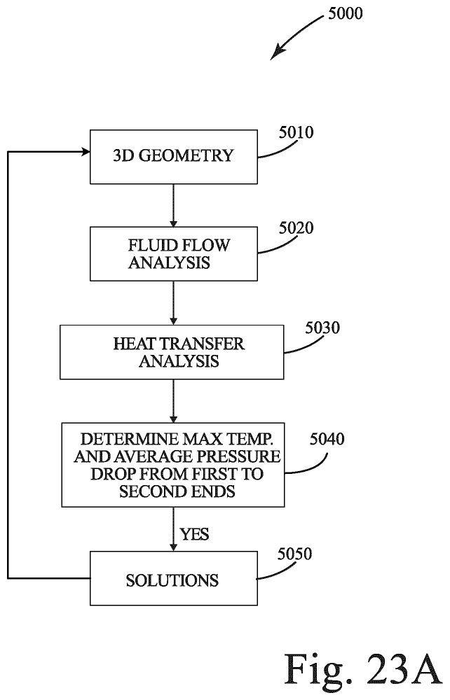

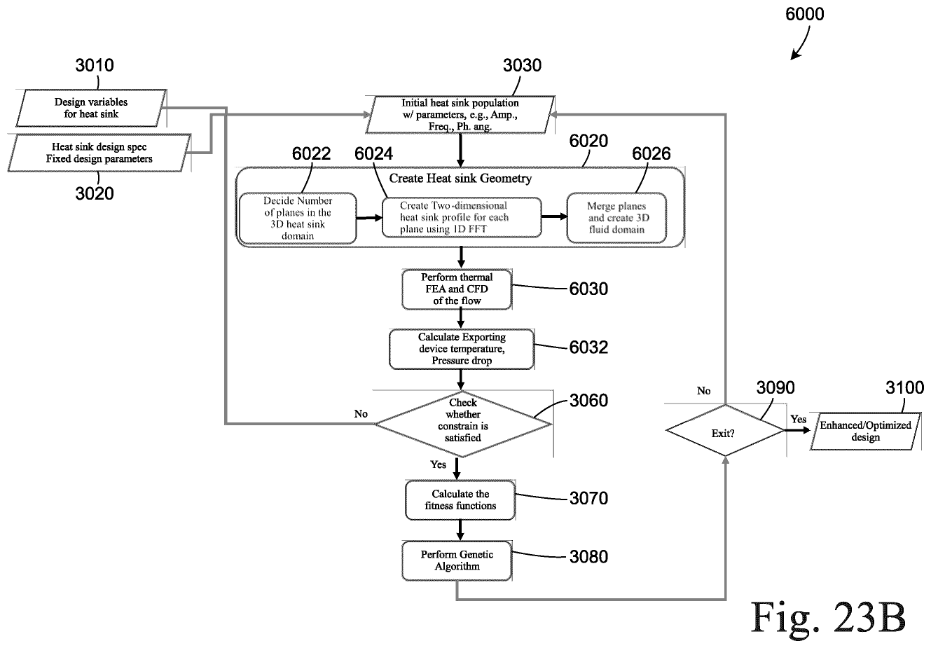

A method of generating the heat sink 400 according to one embodiment is shown in FIG. 23A and generally designated 5000. The method 5000 may be an optimization or enhancement algorithm that begins with creating populations for the design parameters, which are the number of fins represented by the spatial frequency of fins in each plane, the height of the fins and the length of each heat sink 400. Step 5010. In one embodiment, fourteen design parameters may be considered. Initially, many populations may be generated via a genetic algorithm, which may be passed to a computer-aided design suite of the finite element analysis (FEA) software COMSOL. Later, the heat sink structure can be combined with the power module or integrated circuit 50. Herein, the heat sink 400 may be seamlessly connected with the bottom DBC baseplate of the integrated circuit 50. The FEA tool may then be utilized to conduct steady-state analysis and calculated the maximum temperature in the device and the pressure drop for the heat sink design. Steps 5020, 5030, 5040. The genetic algorithm may compare the pressure drop with the constraints, and if successful, the algorithm may take over the optimization process and use the simulation results to compute a heat sink performance matrix. Step 5050. The performance data may be used to calculate the design fitness and create an optimal design space for the heat sink. For instance, a design space for the heat sink can be the pressure drop vs. device temperature plane.

The heat sink 400 may be generated in a manner similar to the heat sink 100 according to the method 3000, e.g., using a genetic algorithm (although the present disclosure is not limited to any particular algorithm for generating the heat sink 400).

In one embodiment, the genetic algorithm may be run for n generations, with each generation operating on m solutions (population size). In the method 3000 for generating the heat sink 400, design parameters were f₁, f₂, f₃, f₄, f₅, A₁, A₂, A₃, A₄, A₅, L₁, L₂, L₃ and L₄. Steps 3010, 3020. A single population in a certain generation consisted of a vector, which is represented by v_{g,j}=[f₁, f₂, f₃, f₄, f₅, A₁, A₂, A₃, A₄, A₅, L₁, L₂, L₃, L₄]. Here, f represents the spatial frequency of fins for each reference section 310, A represents the amplitude for each reference section 310, and L represents the distance between the reference sections 310. The genetic algorithm population at its generation α, P_{g,α}, may be stored using P_{g,α}=[v_{g,1},v_{g,2},v_{g,2}, . . . ,v_{g,m}].

Similar to the heat sink 100, the method 3000 may be utilized to randomly generate initial populations for heat sinks 400. Step 3030. These initial populations may then be passed to an FEA tool, which first creates the heat sink structure, creates assigned boundaries, creates initial conditions, and then solves for the physics. Steps 3040, 3050, 3060. After obtaining the solution, the FEA tool may analyze the results to evaluate the fitness value of each population and use a selection tool to create a mating pool with better fitness values. Step 3060, 3070. The selection tool may use roulette-wheel selection for this operation. The selection probability of a population may be proportional to a fitness value, which means a population with a higher fitness value would have a higher probability of being selected in the pool. The next operation may be “crossover”, in which two parent populations meet and create two offspring populations using genetic crossover. Step 3080. A few additional genetic algorithm operators may be used, such as “diversity control” and “random search”, to control and preserve the population diversity. At the end of the genetic algorithm operations, the newly created population may be passed through a verification stage to determine whether the genetic algorithm should continue the search or not. Step 3090. If the number of generations created is below a certain value, the optimization process may continue until it reaches the desired number of generations. Step 3100.

A method of generating the heat sink 400 according to one embodiment is shown in FIG. 23B and generally designated 6000. The method 6000 may be similar to the method 3000 with similar steps identified by the same respective reference numbers but adapted for evaluation and generation of the heat sink 400 instead of the heat sink 100. For instance, an initial population of heat sinks 400 may be generated based on variables and parameters. Steps 3010, 3020, 3030. However, heat sink geometry generation in step 6020 in the method 6000 may be different from heat sink generation of step 3040 of the method 3000. The heat sink generation step 6020 of the method 6000 may include determining a number of reference sections 310, generating a two-dimensional profile for each reference section 310, and merging the reference sections 310 for generating a heat sink 400 for evaluation. Steps 6022, 6024, 6026. For each heat sink 400 that is generated in the heat sink generation step 6020, a heat sink finite element analysis may be conducted that involves thermal finite element analysis and computational fluid dynamics analysis. Step 6030. Further, evaluation of device temperature and pressure drop for each heat sink 400 may be conducted. Step 6032.

Like method 3000, method 6000 may involve checking whether constraints have been satisfied for the generated heat sinks 400 in step 3060. If yes, fitness calculations and genetic algorithms may be conducted for the generated heat sinks 400. Steps 3070, 3080. As described herein, at the end of the genetic algorithm operations, the newly created population may be passed through a verification stage to determine whether the genetic algorithm should continue the search or not. Step 3090. If the number of generations created is below a certain value, the optimization process may continue until it reaches the desired number of generations Step 3100.

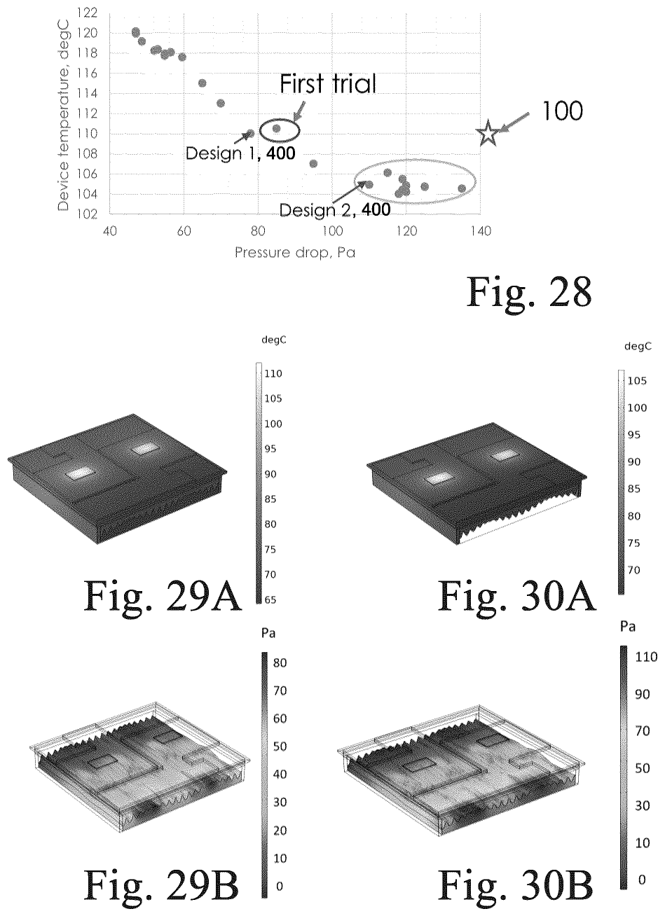

A Pareto chart of multiple iterations of heat sinks 400 is shown in FIG. 28, depicting temperature vs. pressure drop for multiple heat sinks 400 with a comparison against the heat sink 100. For the iterations in the design space of FIG. 28, the objective is to lower device temperature and the constraint is pressure drop with a maximum of 200 Pa. The parameters or variables that may change include harmonics and magnitude of the heat sink fin height. Operating conditions include a total power loss of 200 W, an inlet coolant temperature of 65 deg. C., and a cooling medium 52 that is water-glycol (50-50). Pressure and temperature diagrams for a heat sink in the first design space in FIG. 28 are depicted respectively in FIGS. 29A, 29B; and, pressure and temperature diagrams for a heat sink in the second design space in FIG. 27 are depicted respectively in FIGS. 30A, 30B.

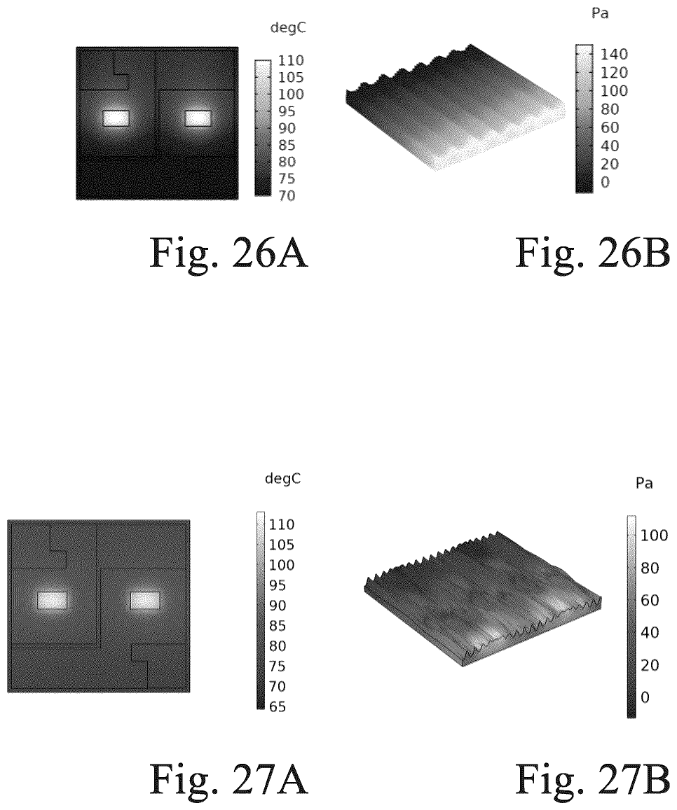

For purposes of comparison, thermal performance of the heat sink 100 according to one embodiment is shown in FIGS. 26A and 26B. The maximum device temperature in the illustrated embodiment is 110° C. at steady state, and the corresponding pressure drop for the cooling medium 52 is approximately 140 Pa.

Turning to FIGS. 27A and 27B, thermal performance of the heat sink 400 according to one embodiment is shown. As can be seen, a maximum device temperature in the illustrated embodiment is 106° C. at steady state, and the corresponding average pressure drop for the cooling medium 52 is approximately 80 Pa.

For the illustrated embodiment, genetic algorithmic optimization have been conducted for 10 generations, and each generation comprised 20 populations. To compare the heat sink 100 against the heat sink 400, the height of the heat sink 400 was maintained at 5 mm. The variables used for generation according to one embodiment include the frequency of fins or number of fins on different planes (e.g., reference sections 310), the amplitude of fins at those corresponding planes (e.g. reference sections 310), and the distance between the planes (e.g., reference sections 310). The optimized heat sink 400 was 50% smaller than a conventional pin-fin heat sink and had 20% lower pressure drop than the heat sink 100 at a similar device temperature.

The below table shows the parameters for the optimized design where f₁, f₂, f₃, f₄ and f₅ represents the spatial frequency of heat sink profiles at reference sections 310-1, 310-2, 310-3, 310-4 and 310-5 in FIG. 24.

| Parameters | Value |
|---|---|
| f₁ | 75 |
| f₂ | 350 |
| f₃ | 350 |
| f₄ | 350 |
| f₅ | 75 |
| A₁ | 3.5 mm |
| A₂ | 1.4 mm |
| A₃ | 2.5 mm |
| A₄ | 1.2 mm |
| A₅ | 1.7 mm |
| L₁ | 10 mm |
| L₂ | 10 mm |
| L₃ | 5 mm |
| L₄ | 15 mm |

A₁, A₂, A₃, A₄ and A₅ are the amplitudes of the heat sink profile curve in reference sections 310-1 to 310-5. L₁ to L₄ are the distance between the reference sections. The frequencies, f value varied from 10 to 400, amplitude A varied from 1 mm to 4 mm and the length or distance between references sections 310, L varied from 5 mm to 15 mm. The objective function is to minimize the device temperatures and the constraint was pressure drop<2 psi.

The maximum device temperature 106° C. in FIG. 27A, and the corresponding average pressure drop was approximately 80 Pa in FIG. 27B, which was 20% lower than that of the heat sink 100 in one embodiment.

The thermal performances of a conventional pin-fin design, heat sink 100, and the heat sink 400 according to one embodiment may be at different flow rates. The evaluation parameter may be a calculated heat transfer coefficient (HTC) according to the following:

htc=Q/AΔT

A is the area through is heat is transferred (so effective heat transfer area), T is temperature, delta T is temperature difference between the coolant and surface which is in contact with coolant.

The HTC of the heat sink 400 in one embodiment may be approximately 10% higher than the HTC of the heat sink 100 in one embodiment and approximately 40% higher than the HTC of a conventional pin-fin heat sink.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A heat sink for extracting heat from an integrated circuit (IC) during operation of the IC, the heat sink comprising:
a solid, thermally conductive material including:
a first surface configured to be thermally coupled with the IC, and
a second surface opposing the first interface, the second surface arranged to contact a cooling fluid; and
a cover arranged and configured to:
encapsulate the cooling liquid between the cover and the second surface, and
form, in conjunction with the second surface, channels that cause the cooling liquid to flow along an effective flow direction,
wherein cross-sections of the second surface that are orthogonal to the effective flow direction are shaped in accordance with different linear combinations of sinusoidal spatial harmonics, each linear combination including a total number of terms, N, that satisfies the conditions 2≤N≠∞, wherein the cross-sections are arranged relative to one another to cause the flow of the cooling liquid to meander along the effective flow direction.

2. The heat sink of claim 1, wherein M≥3 anchor cross-sections from among the cross-sections of the second surface are spaced apart from each other and distributed along the effective flow direction, each anchor cross-section being shaped in accordance with a respective linear combination, and the remaining cross-sections are shaped to merge the M anchor cross-sections smoothly along the effective flow direction.

3. The heat sink of claim 2, wherein the number of anchor cross-sections further satisfies M≤10.

4. The heat sink of claim 1, wherein the total number of terms N satisfies the condition N≤20.

5. The heat sink of claim 1, wherein the terms of the linear combination have corresponding harmonic orders, and a maximum of the harmonic orders is 1000.

6. The heat sink of claim 1, wherein the solid, thermally conductive material comprises one or more of Al and Cu.

7. A power module comprising:
a substrate;
circuitry disposed on the substrate; and
the heat sink of claim 1, wherein the heat sink is disposed on the substrate and is thermally coupled with the circuitry.

8. The power module of claim 7, comprising:
a manifold fluidly connected to the channels of the heat sink and a source of the cooling fluid; and
the manifold configured to supply the cooling fluid, at a first temperature, from the source of the cooling fluid to the heat sink, and return the cooling fluid, at a second temperature larger than the first temperature, from the heat sink back to the source of the cooling fluid.

9. The power module of claim 8, wherein the cooling fluid includes one or more of water and glycol.

10. The power module of claim 7, wherein the power module is configured as a power-converter device, wherein the circuitry comprises Si or SiC-based power-electronic switches.

11. A system for designing a heat sink that is liquid-cooled for cooling a power module, the system comprising:
a data processing apparatus; and
memory encoding instructions that, when executed by the data processing apparatus, cause the system to perform operations including:
(i) accessing parameters comprising (a) a size of the heat sink orthogonal to a flow direction, (b) one or more optimization objectives, and (c) one or more constraints that a combination of the power module and the heat sink must satisfy;
(ii) accessing a design space for M≥3 anchor cross-sections of the heatsink surface shaped in accordance with respective linear combinations of sinusoidal spatial harmonics, wherein each linear combination includes a total number of terms, N, that satisfies the conditions 2≤N≠∞, wherein the design space includes coefficients, spatial harmonics, and phases of the terms, wherein the M anchor cross-sections are spaced apart from each other and distributed along an effective flow direction, and wherein interpolation cross-sections are to be shaped to merge the M anchor cross-sections smoothly along the effective flow direction;
(iii) initializing a population of sets of heat-sink cross sections based on the accessed design space, each set including M anchor cross-sections and interpolated cross-sections;
(iv) iterating the following operations:
(a) performing computational analyses of respective power-module and heat-sink combinations based on an instant population of sets off heat sink cross-sections;
(b) evaluating fitness of respective power-module and heat sink combinations based on the analyzed instant population in view of the optimization objectives and the constraints; and
(c) generating a new population by applying one or more genetic algorithm operators to the instant population evaluated for fitness; then
(v) outputting an optimized population of sets of heat sink cross sections including a set of optimal heat-sink cross sections; and
(vi) selecting, based on a particular one of the optimization objectives, a set of heat-sink cross sections from among the group of optimal sets heat-sink cross sections to be used to fabricate the liquid-cooled heat sink.

12. The system of claim 11, wherein the optimization objectives include one or more of a heat-sink cross section height, a heat-sink volume, or a coolant pressure drop across the heat sink.

13. The system of claim 11, wherein the constraints include one or more of a semiconductor-junction temperature, a heat-sink cross-section height, a heat-sink width, a heat-sink length, a heat-sink volume, a Reynolds number, or a coolant pressure drop across the heat sink.

14. The system of claim 11, wherein the computational analyses include FEA.

15. The system of claim 11, wherein the genetic algorithm operators include one or more of mutation, cross-over, selection, elitism, or diversity control.

16. A heat sink for extracting heat from circuitry during operation of the circuitry, the heat sink comprising:
a first surface configured to be thermally coupled with the circuitry, wherein a thermal profile is defined at least in part by a thermal coupling between the first surface and the circuitry;
a second surface opposing the first surface, the second surface arranged to contact a cooling medium that flows in a flow direction along the second surface;
wherein cross-sections of the second surface that are orthogonal to the flow direction are respectively defined according to plurality of functions, each of the plurality of functions being defined by one or more parameters; and
wherein the one or more parameters of each function are determined based on the thermal profile that is defined at least in part by the thermal coupling between the first surface and the circuitry.

17. The heat sink of claim 16, comprising a cover arranged and configured to encapsulate the cooling medium between the cover and the second surface, the cover configured to form, in conjunction with the second surface, channels that cause the cooling medium to flow along the flow direction.

18. The heat sink of claim 16, wherein each function is a linear combination of sinusoidal spatial harmonics, the linear combination including a total number of terms N that satisfies the conditions 2≤N≤∞.

19. The heat sink of claim 16, wherein the cross sections are arranged relative to one another to cause the flow of the cooling medium to meander along the flow direction.

20. The heat sink of claim 16, wherein M≥3 anchor cross-sections from among the cross-sections of the second surface are spaced apart from each other and distributed along the flow direction, each anchor cross-section being shaped in accordance with a respective function, and the remaining cross-sections are shaped to merge the M anchor cross-sections smoothly along the flow direction.
